(19) United States
(12) Patent Application Publication
(10) Pub. No.: US 2003/0020960 A1
(43) Pub. Date: Jan. 30, 2003

(54) Internet facsimile machine

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/202,052

(22) Filed: Jul. 23, 2002

(30) Foreign Application Priority Data
Jul. 25, 2001 (JP) 2001-224850
Aug. 22, 2001 (JP) 2001-251861
Jul. 25, 2001 (JP) 2001-224888

(51) Int. Cl. B41J 1/00; G06F 15/00; H04N 1/00

(52) U.S. Cl. 358/402; 358/1.15

(57) ABSTRACT

The present invention provides an Internet facsimile machine including a processor having an ability exchanging function for forming an electronic mail including standard format image data and format information of original image data, transmitting the electronic mail, receiving an electronic mail having machine receiving ability information and transmitting the image data formed in accordance with the machine receiving ability information from the original image data. The Internet facsimile machine also includes a controller for determining whether or not to use the ability exchanging function for the transmission of the image data in accordance with a state of the Internet facsimile machine when transmitting the image data.

### FIELD OF THE INVENTION

The present invention relates to an Internet facsimile machine for transmitting and receiving image data by electronic mail, and more particularly, to an Internet facsimile machine provided with a function for transmitting to a receiving side machine, an image data in a format suitable for a receiving ability of the receiving side machine.

### DESCRIPTION OF THE RELATED ART

In a general Internet facsimile communication, a format of an image data to be transmitted and received reciprocally by Internet facsimile machines is standardized (for example, standardized into the image data of A4 in recording paper size, MH (Modified Huffman) method in encoding method, 200 dpi in resolution). Therefore, even in the case the Internet facsimile machine of a transmitting side is not grasping the receiving ability information of the Internet facsimile machine of a receiving side, the transmission and reception can be carried out without problems.

Recently, for transmitting and receiving the image data higher in its image quality than the image data of standardized format (hereinafter referred to as the “standard format”), it is proposed of the Internet facsimile machine for transmitting the image data in the format most appropriate to the receiving ability of the Internet facsimile machine of the receiving side, after obtaining under predetermined method, information concerning the printable recording paper size, receivable resolution, decodable encoding method or the like, as the information concerning the receiving ability of the Internet facsimile machine of the receiving side (hereinafter referred to as the “receiving ability information”).

According to a communication procedure of the abovementioned Internet facsimile communication, first, the Internet facsimile machine of the transmitting side forms an original image data high in the resolution directly from an original or the like scanned by a scanner, and holds onto such an original image data. Then, the Internet facsimile machine of the transmitting side forms an electronic mail that is written with information concerning the formed original image data, and the message for requesting a notification of the receiving ability. In addition, the Internet facsimile machine of the transmitting side converts the format of the original image data, attaches the formed standard format image data to the electronic mail, and transmits the electronic mail. Meanwhile, the Internet facsimile machine of the receiving side that received the electronic mail, forms the electronic mail that is written with the receiving ability information of the machine itself by following the message, and the message indicating the transmission of the image data higher in its image quality. Then, the formed electronic mail is returned to the Internet facsimile machine of the transmitting side. Lastly, the Internet facsimile machine of the transmitting side that received the electronic mail, forms the image data in the format most appropriate to the receiving ability of the Internet facsimile machine of the receiving side in accordance with the receiving ability information, and transmits the image data to the Internet facsimile machine of the receiving side.

However, according to the abovementioned Internet facsimile communication, the Internet facsimile machine of the transmitting side is required to hold onto the original image data until receiving the electronic mail requesting for the high quality image data from the machine of the receiving side. Therefore, the storing source is pressurized until the electronic mail is received, and there is a possibility for various troubles to occur.

Moreover, the Internet facsimile machine corresponding to the abovementioned Internet facsimile communication is only a part of Internet facsimile machines at the present moment. Even when the Internet facsimile machine of the transmitting side attempts to carry out such an Internet facsimile communication, if the Internet facsimile machine of the receiving side is not provided with the function, a response cannot be obtained from the Internet facsimile machine of the receiving side. As a result, the Internet facsimile machine of the transmitting side is to hold onto the original image data meaninglessly for a prescribed period of time, and this may cause the storing source to be pressurized.

In addition, by using the Internet facsimile machine corresponding to the Internet facsimile communication, there is a merit in that the image data in the format most appropriate to the receiving ability of a destination can be transmitted. However, comparing to the general Internet facsimile machine that ends the communication operation by single transmission or receiving of the electronic mail, a longer period of time is taken from the start until the end of the communication operation. Moreover, the object in the transmission of the user who uses the facsimile is varying, and there are cases in which it is desirable to transmit the original under high image quality, and there are also cases in which it is desirable to transmit the original immediately regardless of the image quality of the original to be transmitted.

Notwithstanding, when transmitting the original under the abovementioned Internet facsimile communication (communication using an ability exchanging function) at all times, it is to be against the intention in the transmission of the user that it is desirable to transmit the original immediately. On the other hand, when transmitting under the general Internet facsimile communication, it is to be against the intention in the transmission of the user that it is desirable to transmit the original under high image quality.

### SUMMARY OF THE INVENTION

A first advantage of the present invention is to provide an Internet facsimile machine capable of preventing a storing source from being pressurized by an original image data being held during Internet facsimile transmission using an ability exchanging function, and the problems arising from the former.

A second advantage of the present invention is to provide an Internet facsimile machine capable of not holding onto the original image data when it is obvious that the transmission of the high quality image data is not to be requested further by the Internet facsimile machine of the receiving side, after the standard format image data is transmitted to the Internet facsimile machine of the receiving side.

A third advantage of the present invention is to provide an Internet facsimile machine provided with the ability exchanging function, for transmitting the image data under the transmission method most appropriate to an intention of an operator for the transmission.

The Internet facsimile machine of the present invention determines whether or not to use the ability exchanging function for the transmission of the image data, in accordance with the condition of the machine itself of when transmitting the image data. Therefore, by transmitting the image data by using the ability exchanging function, the Internet facsimile machine of the present invention is capable of preventing the condition of the machine itself from deteriorating.

Furthermore, since the condition of the machine itself is a condition of a free space in an image memory, the pressure on the storing source due to holding the original image data by using the ability exchanging function during the transmission, and the problems occurring from the former, can be prevented from occurring.

In addition, since the condition of the machine itself is a frequency in use per time of the image memory, by carrying out the transmission using the ability exchanging function when the frequency in use per time of the image memory is high, a pleasant usage by the user of other machine can be prevented from being disturbed.

Moreover, the Internet facsimile machine of the present invention is provided with a receiving ability storing function for storing the receiving ability information of the destination machine relating to the destination machine by associating to the destination information stored inside. In the case the receiving ability information of the destination machine that is designated as the destination for the transmission is stored in the receiving ability storing device, the formed image data is transmitted without using the ability exchanging function, in accordance with the receiving ability information. Therefore, by a single transmission of the electronic mail, the image data can be transmitted in the format most appropriate to the receiving ability of the destination machine, and the communication efficiency can be improved.

Moreover, the Internet facsimile machine of the present invention determines whether or not to use the ability exchanging function for the transmission of the image data, in accordance with the communication condition of the network of when transmitting the image data. Therefore, by using the ability exchanging function, the Internet facsimile machine can prevent the network from being congested further, and can also prevent the generation of obstacles or the like in the communication of the machine itself due to the congestion in the network.

Moreover, the Internet facsimile machine of the present invention includes a destination function storing device for storing the function information of the destination machine relating to the destination information by associating to the destination information stored inside, and a destination function displaying device for displaying the function information of the destination machine associated to the destination information when the destination is designated at the transmission. Therefore, in the case the function information of the destination machine is stored in the destination function storing device, when transmitting the image data, the operator is capable of selecting appropriate transmission method, after understanding the function of the destination machine from the displayed information.

Furthermore, the function information of the destination machine is displayed by the destination function displaying device on the display of the Internet facsimile machine. Therefore, the function information of the destination machine can be confirmed on the Internet facsimile machine, and the operation at an operating unit that is also provided on the machine can be carried out easily.

Moreover, the Internet facsimile machine of the present invention includes a destination function storing device for storing the function information of the destination machine relating to the destination information by associating to the destination information stored inside, and a transmitter for transmitting the function information of the destination machine that is associated to the destination information, to other terminal connected through the network when the designation in designated at the transmission. Therefore, in the case the function information of the destination machine is stored in the destination function storing devices, when transmitting the image data, the operator is capable of selecting an appropriate transmission method, by understanding the function of the destination machine from the displayed information.

Moreover, the Internet facsimile machine of the present invention includes a priority condition designating feature for accepting the designation from the outside for giving priority to either a transmission image quality or a transmission time for the transmission of the image data, and a transmission method selector for selecting either the transmission by one electronic mail, or the transmission by a plurality of electronic mails using the ability exchanging function, for the transmission method of the image data. Therefore, by designating either the transmission image quality or the transmission time, the operator who uses the Internet facsimile machine can transmit the image data of the original under the transmission method most appropriate to the intention for the transmission.

Furthermore, the transmission method selector selects the transmission by a plurality of electronic mails using the ability exchanging function when the priority condition designated through the priority condition designating feature is the transmission image quality, and selects the transmission by one electronic mail when the designated priority condition is the transmission time. Therefore, by designating either the transmission image quality or the transmission time, the operator who uses the Internet facsimile machine is capable of transmitting the image data of the original under the transmission method most appropriate to the intention of the operator for transmission.

Furthermore, the Internet facsimile machine of the present invention includes a receiving ability storing device for storing the receiving ability information of the destination machine relating to the destination information by associating to the destination information stored inside. In the case the receiving ability information of the destination machine designated as the destination for transmission is stored in the receiving ability storing device, the transmission method selector selects the transmission by one electronic mail as the transmission method of the image data, regardless of the priority condition, and the image data formed in accordance with the receiving ability information is transmitted under one electronic mail. Therefore, in the case the receiving ability information of the destination machine is stored, the high quality image data can be transmitted within a short period of time.

Furthermore, the Internet facsimile machine of the present invention includes a selector for designating whether or not to request a delivery confirmation mail at the transmission. Therefore, when the delivery confirmation mail is unnecessary for the operator, by not requesting the delivery confirmation mail, the communication time can be shortened by the time until the delivery confirmation mail is returned.

### BRIEF DESCRIPTION OF THE DRAWINGS

FIG. 1 is a block diagram showing an example of a structure of an Internet facsimile machine according to the present invention;

FIG. 2 is a view showing an example of data table that stores receiving ability information or the like of destination machines in association with destination information;

FIG. 3 is a view useful for explaining communication mode, and is a sequence diagram showing communication procedure between an Internet facsimile machine of a transmitting side and an Internet facsimile machine of a receiving side;

FIG. 4 is a view showing an example of electronic mail that is attached with standard format (or high quality) image data;

FIG. 5 is a view showing an example of electronic mail that is attached with the standard format image data, wherein the electronic mail includes a message for requesting return of delivery confirmation mail, ability exchanging notification information, and original image data format information;

FIG. 6 is a view showing an example of electronic mail that is transmitted by the Internet facsimile machine of the receiving side for requesting the high quality image data to the Internet facsimile machine of the transmitting side;

FIG. 7 is a view showing an example of electronic mail that is attached with the high quality image data which is to be transmitted by the Internet facsimile machine of the transmitting side in accordance with request from the Internet facsimile machine of the receiving side;

FIG. 8 is a view showing an example of delivery confirmation mail that is transmitted by the Internet facsimile machine of the receiving side in accordance with request from the Internet facsimile machine of the transmitting side;

FIG. 9 is a block diagram showing an example of network environment that is provided with the Internet facsimile machine of the present invention;

FIG. 10 is a flow chart showing operation of when the Internet facsimile machine of the transmitting side transmits the image data;

FIG. 11 is a flow chart showing operation of when the Internet facsimile machine of the transmitting side transmits the image data;

FIG. 12 is a flow chart showing operation of when the Internet facsimile machine of the transmitting side transmits the image data under the communication mode 4 or the communication mode 5;

FIG. 13 is a flow chart showing operation of when the Internet facsimile machine of the transmitting side transmits the image data under the communication mode 1 or the communication mode 2;

FIG. 14 is a flow chart showing operation of when the Internet facsimile machine of the transmitting side transmits the image data under the communication mode 3;

FIG. 15 is a view showing an example of delivery confirmation mail request screen, communication mode designation screen, and communication mode selection screen;

FIG. 16 is a view showing an example of communication mode changing screen;

FIG. 17 is a flow chart showing operation of when the Internet facsimile machine of the receiving side receives the electronic mail;

FIG. 18 is a flow chart showing operation of when the Internet facsimile machine of the transmitting side receives the electronic mail;

FIG. 19 is a view showing an example of data table that stores function information or the like of the destination machines in association with the destination information.

FIG. 20 is a flow chart showing operation of when the Internet facsimile machine of the transmitting side transmits the image data;

FIG. 21 is a flow chart showing operation of when the Internet facsimile machine of the transmitting side transmits the image data;

FIG. 22 is a flow chart showing operation of when the Internet facsimile machine of the transmitting side transmits the image data;

FIG. 23 is a flow chart showing operation of when the Internet facsimile machine of the transmitting side transmits the image data;

FIG. 24 is a view showing an example of receiving ability displaying screen, transmission mode inputting screen, and the like;

FIG. 25 is a view showing an example of format confirmation screen and format designation screen;

FIG. 26 is a view showing an example of delivery confirmation notification designation screen;

FIG. 27 is a view showing an example of data table that stores the receiving ability information or the like of the destination machines in association with the destination information.

FIG. 28 is a flow chart showing operation of when the Internet facsimile machine of the transmitting side transmits the image data;

FIG. 29 is a flow chart showing operation of when the Internet facsimile machine of the transmitting side transmits the image data by designating the communication mode 4 or the communication mode 5;

FIG. 30 is a flow chart showing operation of when the Internet facsimile machine of the transmitting side transmits the image data by designating the communication mode 1 or the communication mode 2;

FIG. 31 is a flow chart showing operation of when the Internet facsimile machine of the transmitting side transmits the image data by designating the communication mode 3; and

FIG. 32 is a view showing an example of priority condition designation screen.

### DETAILED DESCRIPTION OF THE PREFERRED EMBODIMENTS

The Internet facsimile machine according to a first embodiment of the present invention will be described in accordance with the accompanying drawings. The Internet facsimile machine that is to be a side to transmit an image data will be referred to as “Internet facsimile machine of the transmitting side”, and the Internet facsimile machine that is to be a side to receive the image data will be referred to as “Internet facsimile machine of the receiving side”.

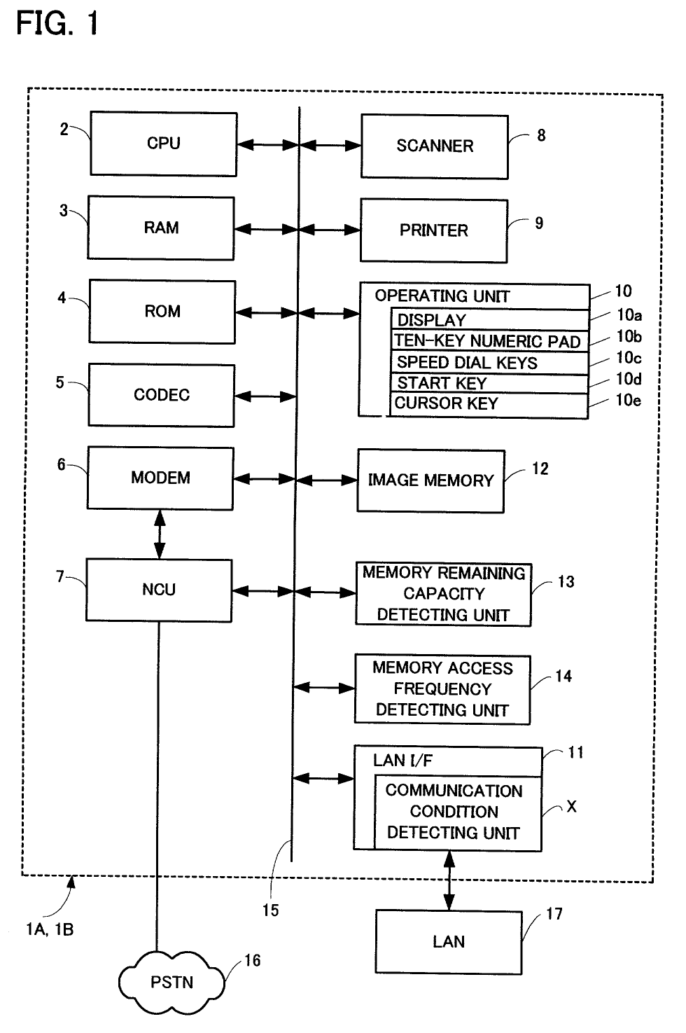

The Internet facsimile machine of the transmitting side and the Internet facsimile machine of the receiving side have the same structure, and the specific configuration is shown in FIG. 1. That is, each of the Internet facsimile machines 1A, 1B includes a CPU (Central Processing Unit) 2, a RAM (Random Access Memory) 3, a ROM (Read Only Memory) 4, a codec 5, a modem 6, an NCU (Network Control Unit) 7, a scanner 8, a printer 9, an operating unit 10, a LAN I/F (Local Area Network Interface) 11, an image memory 12, a memory remaining capacity detecting unit 13, a memory access frequency detecting unit 14, and a network communication condition detecting unit X. Each of the units 2 through 14 and X are connected to each other by a bus 15 so that communication can be carried out.

The CPU 2 controls each of the devices composing the Internet facsimile machine 1A and the Internet facsimile machine 1B, in accordance with a prescribed program.

The RAM 3 functions as a storing unit for storing in advance, for example, FAX numbers, e-mail address, data tables which are to be described later on, and also functions as a storing unit for storing various data or the like to be accumulated temporarily.

The ROM 4 stores, for example, various programs for controlling the operation of each of the devices of the Internet facsimile machines 1A, 1B by the CPU 2, and a program for converting a format of the image data.

The codec 5 encodes and decodes according to a plurality of protocols. In other words, the codec 5 encodes the image data or the like scanned by the scanner 8 under MH (Modified Huffman), MR (Modified Read), MMR (Modified Modified Read) methods or the like for transmitting the image data, and decodes the received image data. Moreover, the codec 5 is also capable of encoding and decoding by corresponding to TIFF (Tagged Image File Format), which is the image format used generally in computers. Further, the specification of the TIFF is publicized by the U.S. Adobe System.

The modem 6 carries out modulation and demodulation of the data to be transmitted and received in accordance with, for example, ITU-T (International Telecommunication Union-Telecommunications) Recommendation V. 34 standard, or others similar to this standard.

The NCU 7 is a network control device for making a telephone call, or disconnecting by controlling the telephone line, and is connected to PSTN (Public Switched Telephone Network) 16.

The scanner 8 scans the image data of an original, and outputs the image data converted into a binary of black and white.

The printer 9 is includes an electrophotographic method or the like, forms the received image data as the image onto a recording paper, and discharges the recording paper (prints out). For example, in accordance with the indication from the CPU 2, the printer 9 prints out the image data of the original that is scanned by the scanner 8, the image data received by a facsimile, the image data of an attached file or the text data of a main text that are received by the Internet facsimile.

The operating unit 10 includes for example, a display 10a for displaying information concerning the condition of the Internet facsimile machines 1A, 1B and various operation instruction screen, a ten-key numeric pad 10b for inputting the FAX numbers or the like, speed dial keys 10c for calling from speed dial numbers, a start key 10d for starting scanning operation of the original and so forth, a cursor key 10e for transferring reversing display within the display 10a. Various operations are carried out from the operating unit 10.

The LAN I/F 11 includes an interface with LAN (Local Area Network) 17, and connects the LAN 17 and the Internet facsimile machines 1A, 1B in the manner the communication can be carried out.

The image memory 12 temporarily stores, for example, the image data received from outside, the image data scanned by the scanner 8, and the image data converted in its format from these image data.

The memory remaining capacity detecting unit 13 detects the amount of free space in the image memory 12, and provides the information according to the request from the CPU 2.

The memory access frequency detecting unit 14 detects the access frequency to the image memory 12, and provides the information according to the request from the CPU 2. As access becomes more frequent, the percentage of accessed time to unit time (for example, 1 minute) is detected. For example, in the case there is a memory access for 30 seconds per 1 minute, the access frequency is to be 50%.

The network communication condition detecting unit X detects packet quantity of the entire LAN 17 at the position of the LAN I/F 11, and provides the information according to the request from the CPU 2.

The Internet facsimile machines 1A, 1B are provided with a function for transmitting and receiving by the facsimile, the image data of the original or the like by G3 method or the like. In addition, the Internet facsimile machines 1A, 1B are also provided with TCP/IP (Transmission Control Protocol/Internet Protocol) which is the Internet standard protocol, and an Internet facsimile function for transmitting and receiving the image data of the original or the like by the electronic mail. Further, for the image data to be transmitted and received by the electronic mail, the image data is formed in the TIFF format, made into a text in accordance with Base 64 or the like of MIME (Multipurpose Internet Mail Extensions), and is then attached to the electronic mail.

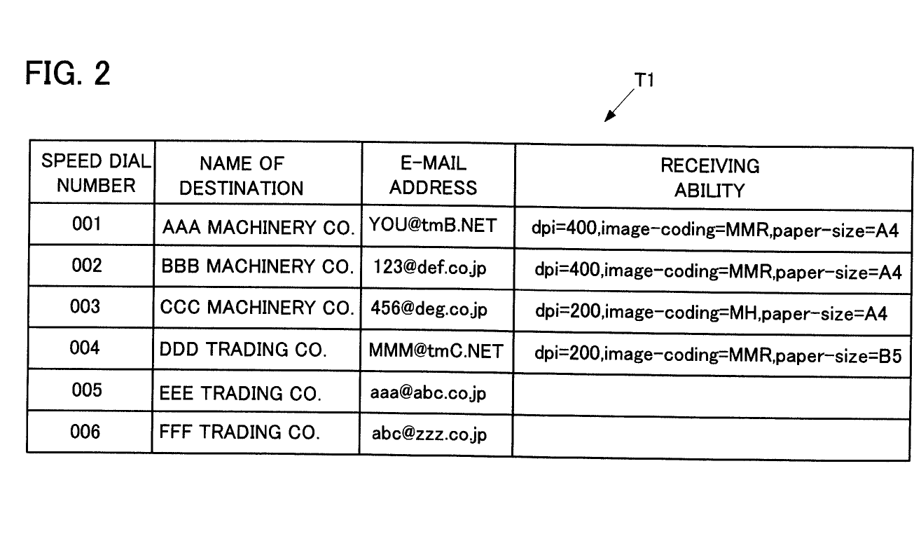

In addition, a data table T1 shown in FIG. 2 is stored in a prescribed storing area in the RAM 3 of the Internet facsimile machine of the transmitting side 1A. The data table T1 stores e-mail addresses (destination information) that are assigned and registered to each speed dial number by the operator, and the information concerning the destination machine that is memorized in association with the e-mail address. By describing in detail, the data table T1 includes “speed dial number” column, “name of destination” column, “e-mail address” column, and “receiving ability” column, and various information is stored in each of the columns per speed dial number that is registered in the “speed dial number” column. The information stored in each column can be set and obtained by the operation by the operator from the operating unit 10 or a client PC that is to be described later on.

In the “name of destination” column in the data table T1, the information concerning the name of the destination, such as the name or the company name of the destination, are stored. The data table T1 is referred to when transmitting from the speed dial number, and the name of the destination is displayed on the display 10a or the like. In the “e-mail address” column, the e-mail address as the destination information is stored, and when the speed dial number is designated at the transmission, the e-mail address stored in the “e-mail address” column is designated as the destination of the transmission.

In the “receiving ability” column, for example, the information concerning the resolution that can be received and processed by the destination machine is written after “dpi=”, the information concerning the encoding method of the destination machine is written after “image-coding=”, and the information concerning the printable recording paper size of the destination machine is written after “paper-size=”.

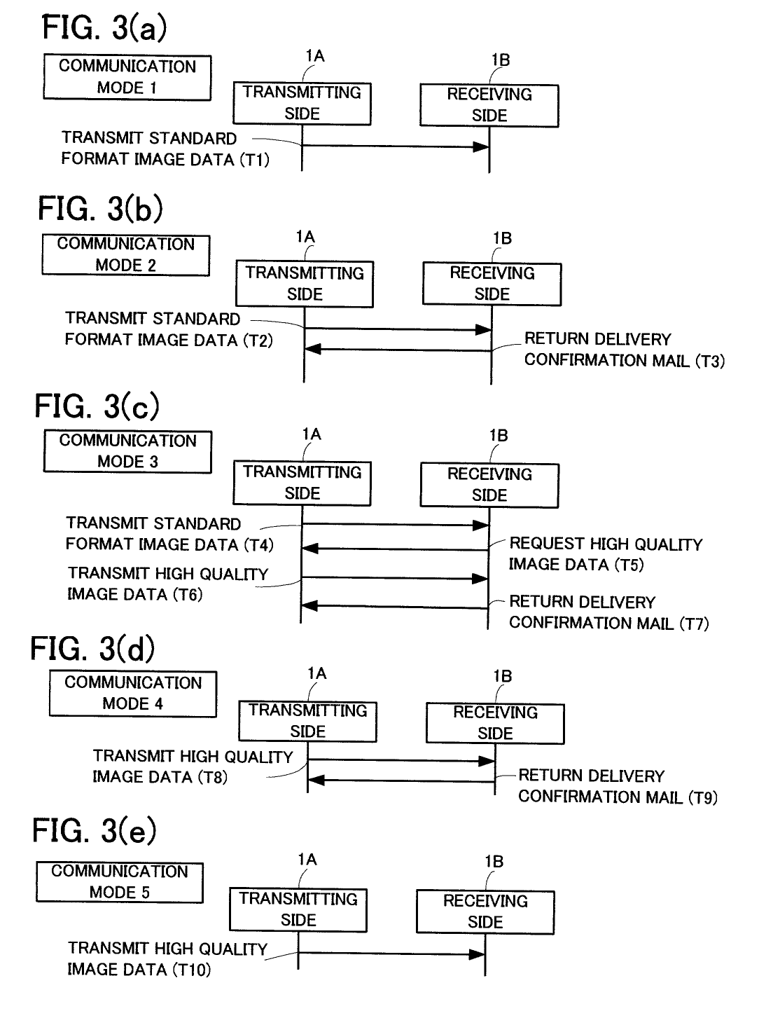

Next, a communication mode to be corresponded by the Internet facsimile machine of the transmitting side 1A will be described. As shown in FIG. 3, the Internet facsimile machine 1A corresponds to five types of communication modes, from “communication mode 1” through “communication mode 5”.

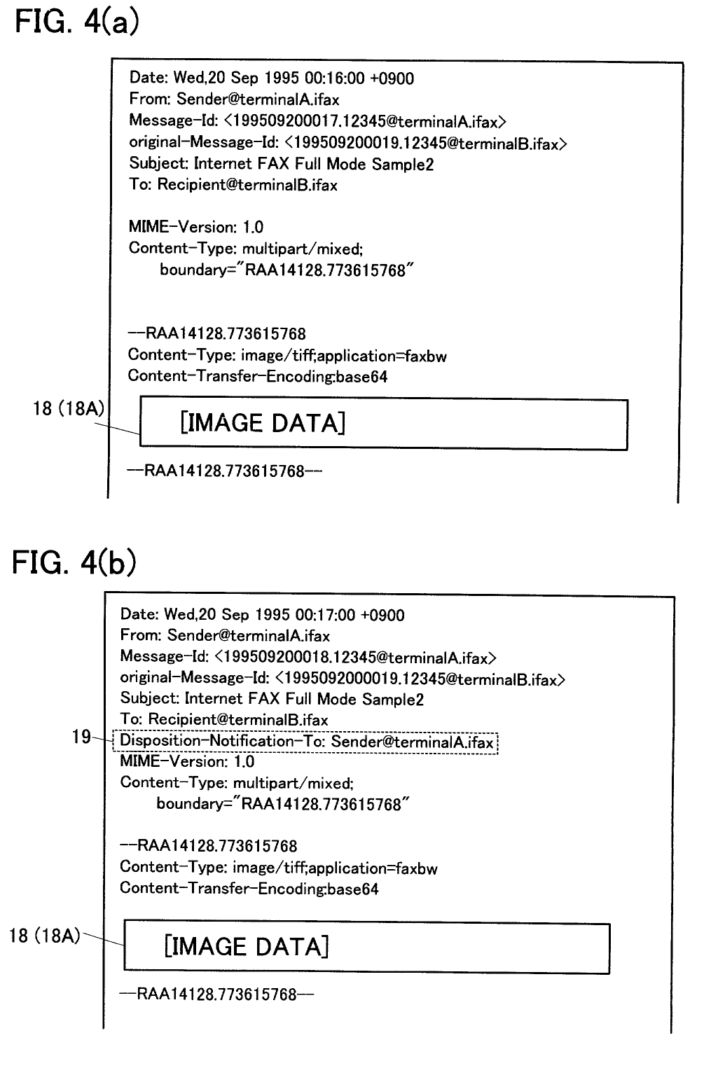

That is, as shown in FIG. 3(a), according to the “communication mode 1”, the Internet facsimile machine of the transmitting side 1A carries out a normal Internet facsimile transmission (T1). In other words, the format of the original image data is converted to form the standard format image data (A4 in the recording paper size, MH method in the encoding method, 200 dpi in the resolution, etc.). Then, the electronic mail is formed that is attached with a standard format image data 18 as shown in FIG. 4(a), and the electronic mail is transmitted. At the time being, the original image data is deleted after the transmission of the standard format image data. Meanwhile, the Internet facsimile machine of the receiving side 1B that receives the electronic mail, carries out a normal receiving processing, such as printing out the received standard format image data.

As shown in FIG. 3(b), according to the “communication mode 2”, the Internet facsimile machine of the transmitting side 1A converts the format of the original image data, and forms the standard format image data. Then, the Internet facsimile machine 1A forms the electronic mail as shown in FIG. 4(b) that is written with a message 19 for requesting the return of the electronic mail for notifying a delivery confirmation (hereinafter referred to as the “delivery confirmation mail”), and attached with the formed standard format image data 18, and transmits the standard format image data (T2). Next, when the Internet facsimile machine of the receiving side 1B receives the electronic mail, the normal receiving processing such as printing is carried out, and also, in accordance with the message 19, the delivery confirmation mail is formed and returned to the Internet facsimile machine of the transmitting side 1A (T3). Further, in this patent specification, a function for returning the delivery confirmation mail after receiving the electronic mail that is written with the message 19 for requesting the return of the delivery confirmation mail, will be referred to as the “delivery confirmation function”.

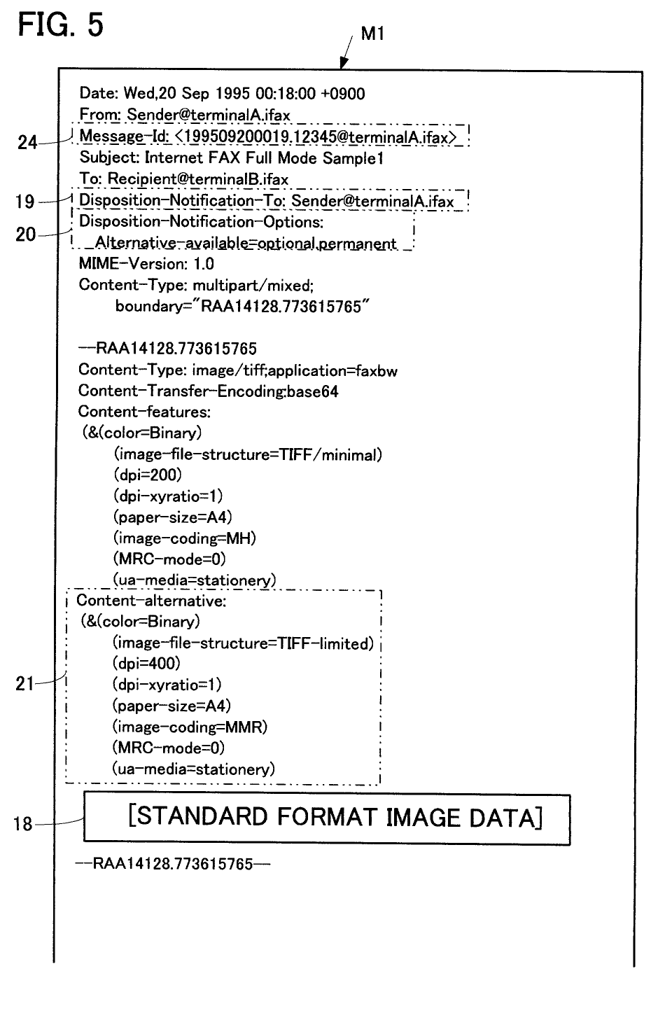

As shown in FIG. 3(c), according to the “communication mode 3”, the Internet facsimile machine of the transmitting side 1A converts the format of the original image data, and forms the standard format image data. Then, the Internet facsimile machine of the transmitting side 1A forms the electronic mail M1 as shown in FIG. 5 that is written with the message 19 for requesting the return of the delivery confirmation mail to the destination machine, an ability exchanging notification information 20 for notifying that the image data higher in its quality than the attached standard format image data will be transmitted when there is a prescribed request, and an information 21 concerning the format of the original image data (hereinafter referred to as the “original image data format information”). Then, the electronic mail M1 is attached with a standard format image data 18, and is transmitted (T4).

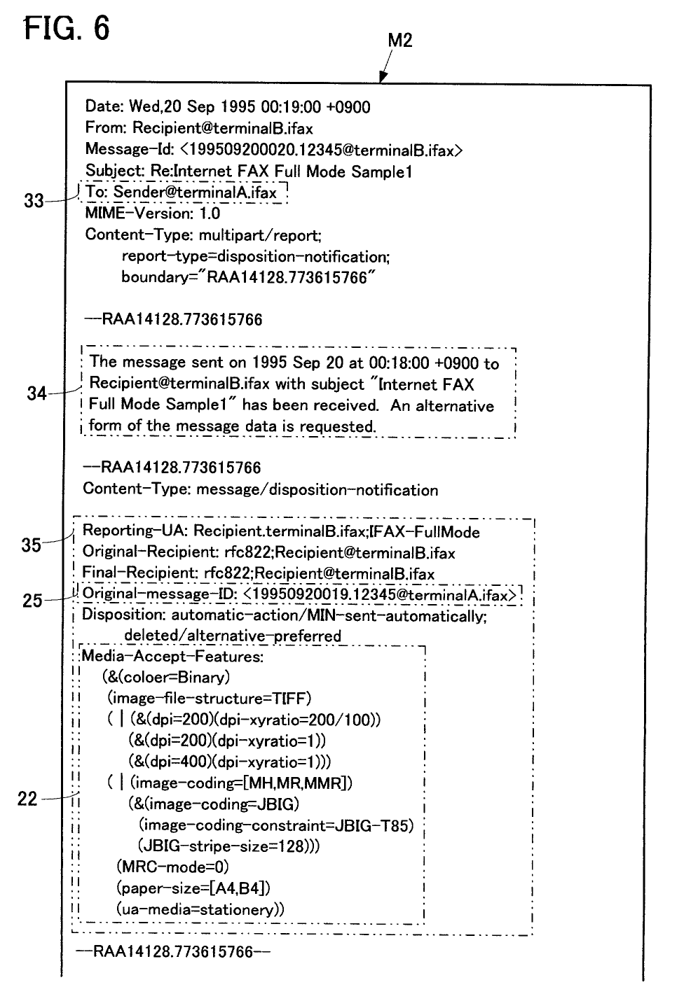

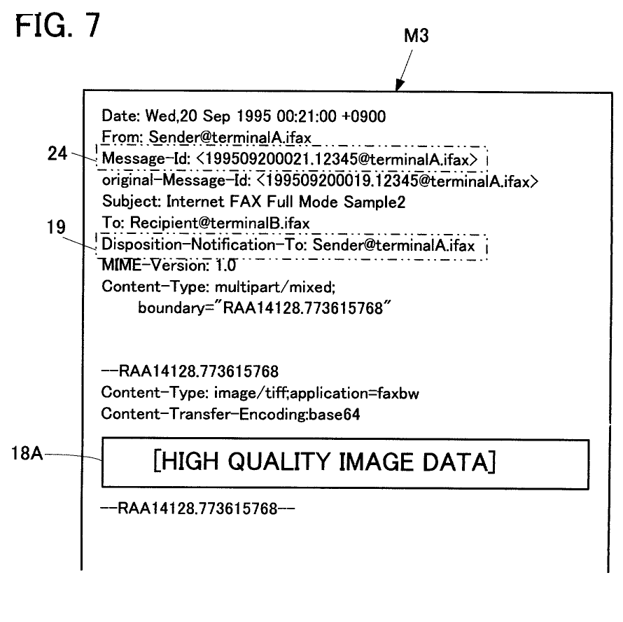

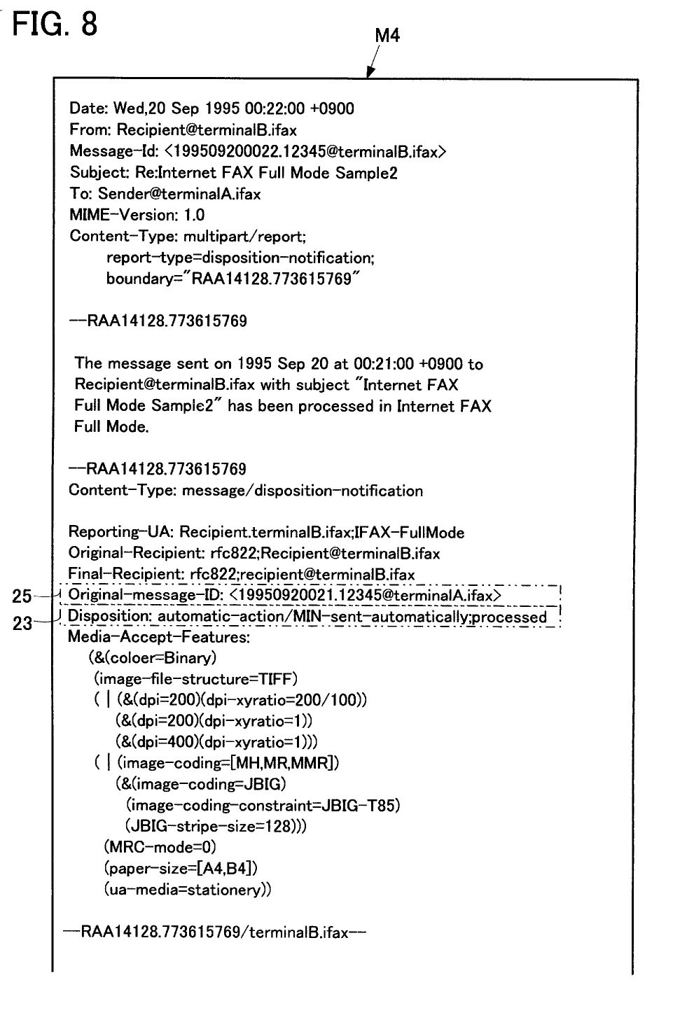

Meanwhile, when receiving the electronic mail M1, the Internet facsimile machine of the receiving side 1B obtains the ability exchanging notification information 20 and the original image data format information 21 from the received electronic mail M1, and forms the electronic mail M2 as shown in FIG. 6 for example, that is written with the information 22 concerning the receiving ability of the Internet facsimile machine 1B (hereinafter referred to as the “receiving ability information”), and returns the electronic mail M2 to the Internet facsimile machine of the transmitting side 1A (T5). Then, when receiving the electronic mail M2, the Internet facsimile machine of the transmitting side 1A forms the image data of the format corresponding to the receiving ability of the Internet facsimile machine of the receiving side 1B (hereinafter referred to as the “high quality image data”), by converting the format of the original image data in accordance with the receiving ability information 22. In addition, the Internet facsimile machine 1A forms the electronic mail M3 as shown in FIG. 7 that is attached with the high quality image data 18A, wherein the electronic mail is written with the message 19 for requesting the return of the delivery confirmation mail to the destination machine, and then the electronic mail M3 is transmitted to the Internet facsimile machine of the receiving side 1B (T6). Lastly, when receiving the electronic mail M3, the Internet facsimile machine of the receiving side 1B forms the electronic mail M4 as shown in FIG. 8 for example, wherein the delivery confirmation message 23 and the information designated at the message ID column 24 of the received electronic mail M3 are written in the original message ID column 25. Then, the electronic mail M4 is returned to the Internet facsimile machine of the transmitting side 1A (T7). Further, in this patent specification, a function for dealing with a series of the communication procedure of T4 through T7 carried out between the Internet facsimile machine of the transmitting side 1A and the Internet facsimile machine of the receiving side 1B will be referred to as the “ability exchanging function”.

As shown in FIG. 3(d), according to the “communication mode 4”, the Internet facsimile machine of the transmitting side 1A forms the image data higher in its quality than the standard format image data, attaches the formed high quality image data 18A to the electronic mail that is written with the message 19 for requesting the return of the delivery confirmation mail, as shown in FIG. 4(b), and then transmits the electronic mail (T8). Next, when receiving the electronic mail, the Internet facsimile machine of the receiving side carries out the normal receiving processing such as printing of the received high quality image data 18A, and also, in accordance with the message 19, forms the delivery confirmation mail, and returns the mail to the Internet facsimile machine of the transmitting side 1A (T9).

As shown in FIG. 3(e), according to the “communication mode 5”, the Internet facsimile machine of the transmitting side 1A forms the image data higher in its quality than the standard format image data, and forms the electronic mail as shown in FIG. 4(a), not including the message 19 for requesting the return of the delivery confirmation mail. Then, the formed high quality image data 18A is attached to the electronic mail, and the electronic mail is transmitted (T10). Meanwhile, the Internet facsimile machine of the receiving side 1B that receives the electronic mail carries out the normal receiving processing such as printing out the received high quality image data 18A.

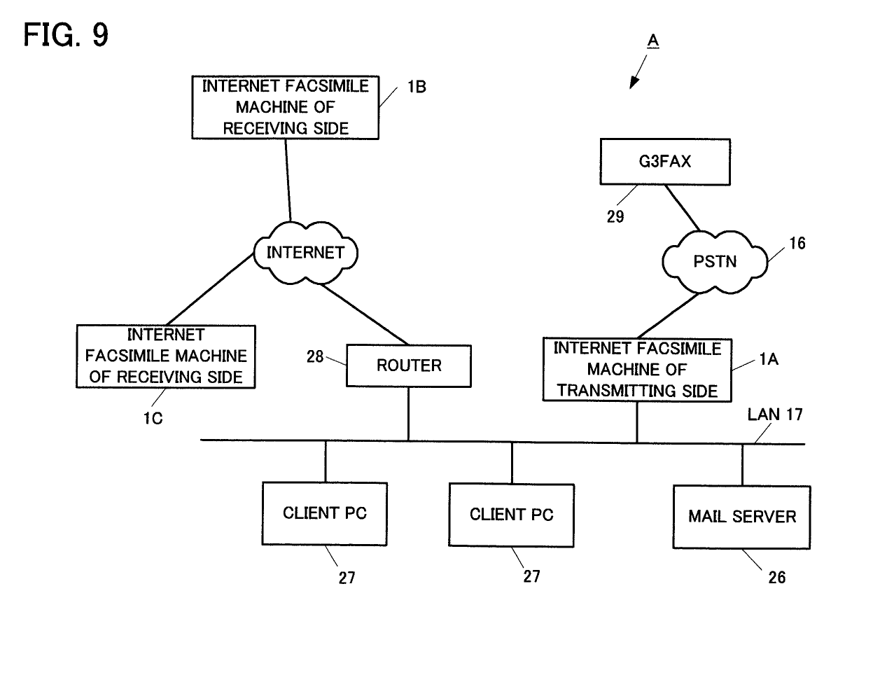

The Internet facsimile machine of the transmitting side 1A and the Internet facsimile machine of the receiving side 1B having the abovementioned hardware structure and various function, are used by being provided in a network environment (A) as shown in FIG. 9. In other words, the Internet facsimile machine of the transmitting side 1A is connected reciprocally to a mail server 26, a client PC 27 that is under command of the Internet facsimile machine of the transmitting side 1A, a router 28 or the like through the LAN 17 in the manner the communication can be carried out. Moreover, the Internet facsimile machine of the transmitting side 1A is capable of carrying out the communication through the Internet with the Internet facsimile machine of the receiving side 1B having the ability exchanging function, and the Internet facsimile machine 1C not having the ability exchanging function. In addition, the Internet facsimile machine 1A is also capable of transmitting and receiving the image data of G3 format with other G3 FAX terminal 29 through the PSTN 16.

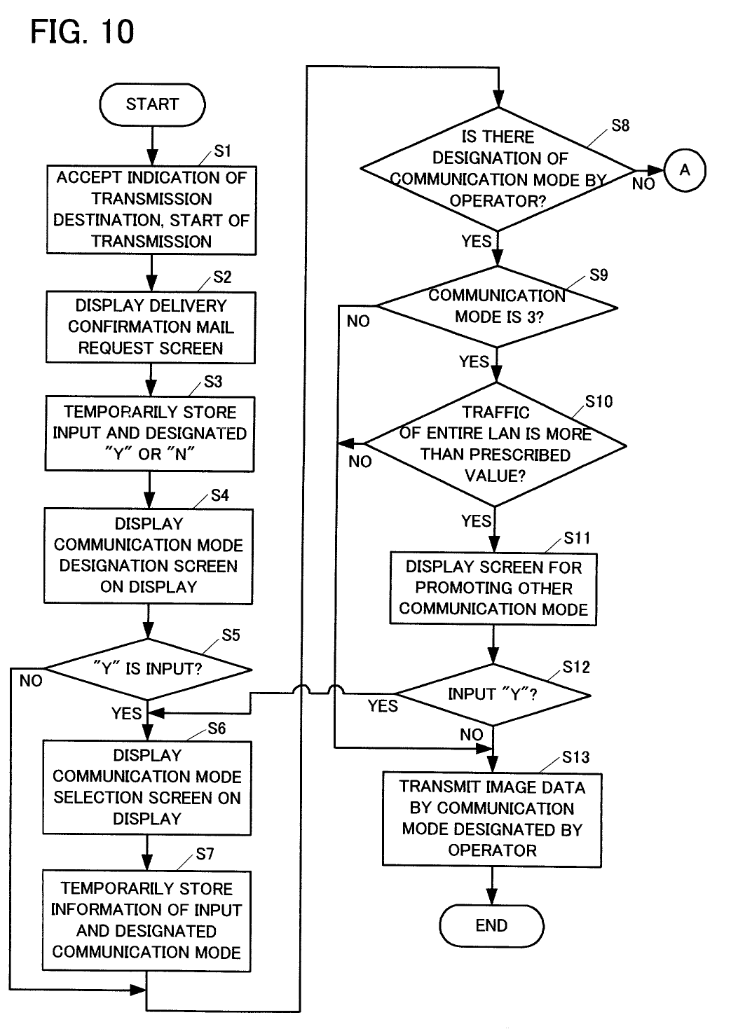

Next, the operation of the Internet facsimile machine of the transmitting side 1A that is provided in the network environment (A), of when transmitting the image data formed by the original being scanned from the scanner 8, or the image data received from the client PC 27 for the facsimile transmission, will be described in accordance with the flow charts shown in FIG. 10 through FIG. 14. Further, the operation to be described in accordance with the flow charts is carried out following the command generated by the CPU 2 in accordance with the control program or the like that is stored in the ROM 4 of the Internet facsimile machine of the transmitting side 1A.

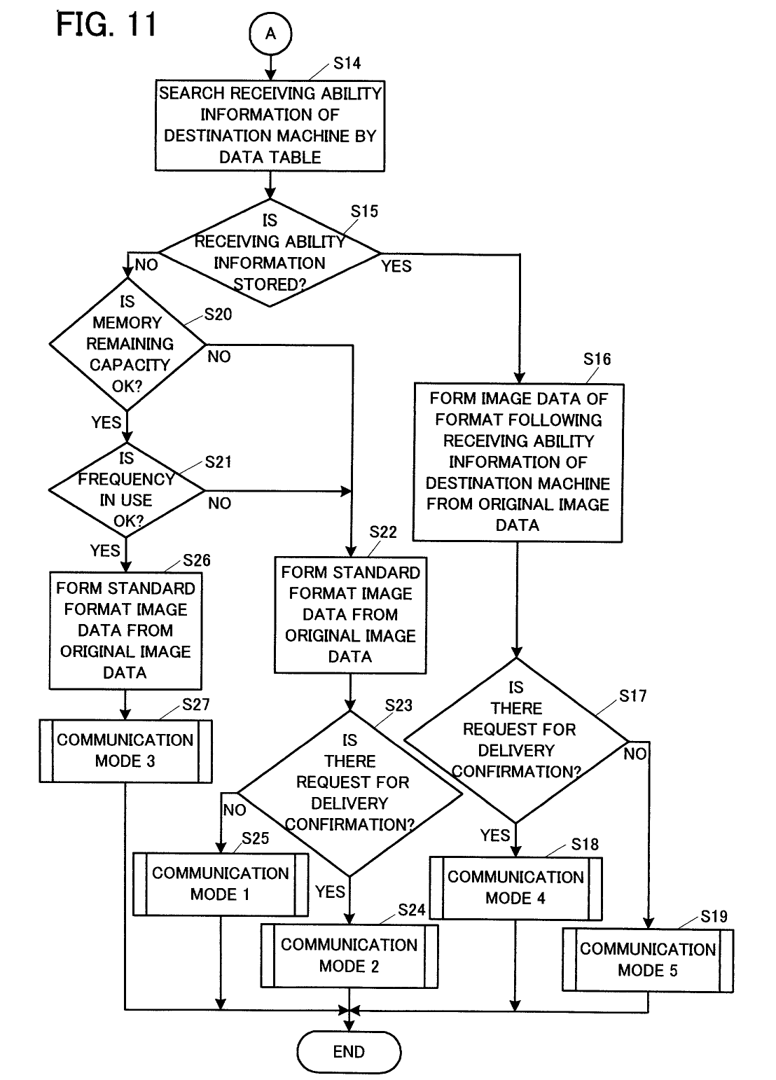

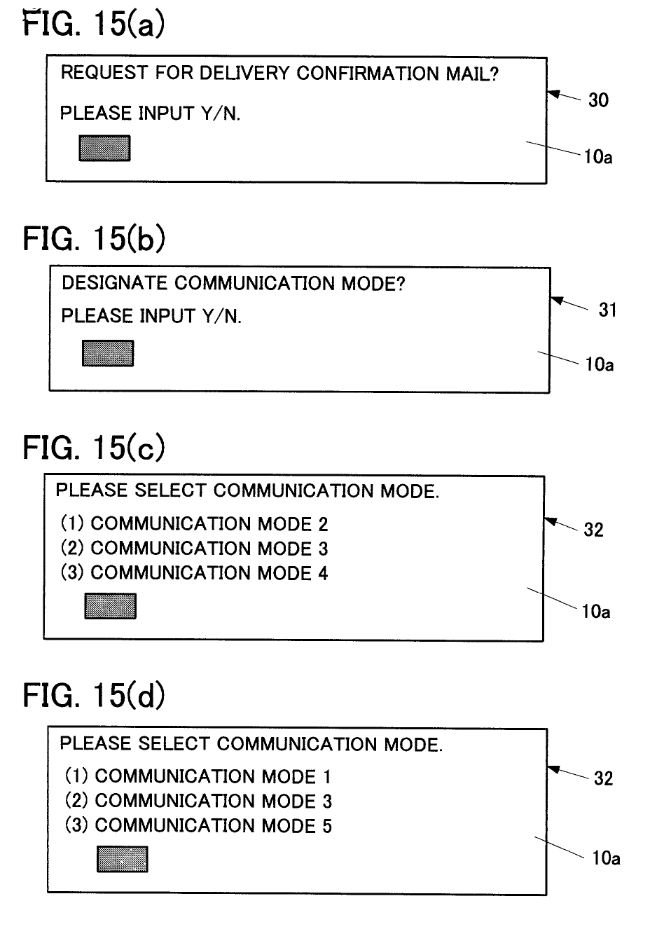

First, when the indication for the transmission destination and the start of the transmission of the image data is carried out by the operation from the operating unit 10 or the client PC 27 by the operator, as shown in the flow charts of FIG. 10 and FIG. 11, the Internet facsimile machine of the transmitting side 1A accepts the indication (S1). Then, a delivery confirmation mail request screen 30 as shown in FIG. 15(a) is displayed on the display 10a for requesting to the operator for the indication of whether or not to request the delivery confirmation mail to the destination (S2). Next, when “Y” is input by the operator to request the delivery confirmation mail, or when “N,” is input to not request the delivery confirmation mail, “Y” or “N” is stored temporarily to the prescribed storing field within the RAM 3 (S3). In addition, a communication mode designation screen 31 as shown in FIG. 15(b) is displayed on the display 10a for requesting to the operator for the indication of whether or not to designate the communication mode for the transmission (S4). Then, when “Y” is input as to designate the communication mode (S5), a communication mode selection screen 32 as shown in FIG. 15(c) or FIG. 15(d) is displayed on the display 10a (S6), and the information of the input communication mode is stored temporarily to the prescribed storing field within the RAM 3 (S7). The screen 32 shown in FIG. 15(c) is displayed when “Y” is input as to request the delivery confirmation mail in the delivery confirmation mail request screen 30. The screen 32 shown in FIG. 15(d) is displayed when “N” is input. Further, when the transmitting operation is carried out at the client PC 27, each of the screen information of the delivery confirmation mail request screen 30, the communication mode designation screen 31, and the communication mode selection screen 32 are transmitted to the client PC 27.

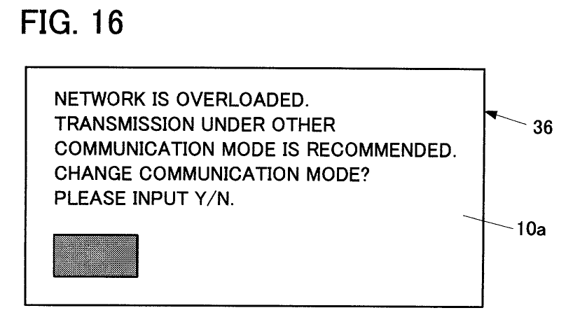

Next, it is determined whether or not there is the designation for the communication mode by the operator in accordance with the information that is stored in S7 (S8). In the case there is the designation for the communication mode, it is determined whether or not the designated communication mode is the “communication mode 3” (S9). In the case of the “communication mode 3”, the operation to be followed is decided in accordance with the communication condition of the LAN 17. In other words, it is determined whether or not traffic of the entire LAN 17 detected by the communication condition detecting unit X is exceeding the predetermined amount (random value, such as 30 Mbps, 60 Mbps, etc. are set by the apparatus setting) (S10). In the case the traffic of the entire LAN 17 is exceeding the predetermined amount, a communication mode changing screen 36 as shown in FIG. 16 for recommending other communication mode is displayed on the display 10a (S11). In the case the traffic is not exceeding the predetermined amount, other operations to be described later on is carried out. Further, the communication condition detecting unit X observes the packet amount of the entire LAN 17 as described above, however, in the case the information of the entire LAN 17 cannot be obtained at the position of the LAN I/F 11 due to the usage of switching hub or the like, a connection command is transmitted to a specific server or the like, and by measuring the time from the transmission until the response, the traffic within the LAN 17 can be grasped. Further, when the transmission operation is carried out at the client PC 27, the screen information of the communication mode changing screen 36 in S11 is transmitted to the client PC 27, as in the same manner as when displaying the delivery confirmation mail request screen 30 or the like.

In the communication mode changing screen 36, when “Y” is input by the operator as to change the communication mode (S12), it proceeds to S6. When “N” is input as to transmit under the “communication mode 3” (S12), or when it is determined that the communication mode is not the “communication mode 3” in S9, and when it is determined that the traffic within the LAN 17 is less than the prescribed amount in S10, the image data is transmitted under the communication mode designated by the operator of which is stored in S7 (S13).

Meanwhile, when it is determined in S8 that there is no indication for the communication mode by the operator, the receiving ability information of the destination machine is searched in accordance with the data table T1 (S14). In the case the destination is designated by the speed dial number, the receiving ability information stored in the “receiving ability” column is searched for the designated speed dial number in the data table T1. In the case the destination is input and designated directly by the input from the operating unit 10 or the client PC 27 without using the speed dial number, the “e-mail address” column in the data table T1 is searched for the input and designated destination, and in the case the there is a corresponding e-mail address, the receiving ability information is searched in the “receiving ability” column for the corresponding destination.

As a result of the searching, in the case the receiving ability information of the destination is stored in the “receiving ability” column in the data table T1 (S15), the image data (high quality image data) in the format following the receiving ability information that is stored in the “receiving ability” column for the e-mail address in the data table T1, is formed from the original image data (S16). Then, it is determined whether or not there is the request for the delivery confirmation in accordance with the information stored in S3 (S17). In the case it is determined that there is the request for the delivery confirmation, the transmission is carried out under the communication mode 4 (S18), and in the case it is determined that there is no request for the delivery confirmation, the transmission is carried out under the communication mode 5 (S19).

In the case it is determined in S15 that the receiving ability information for the destination is not stored in the “receiving ability” column in the data table T1 as a result of the searching, it is determined whether or not the free space in the image memory 12 detected by the memory remaining capacity detecting unit 13 is larger than a threshold (for example, 30% of the entire storing capacity, 1 megabyte, etc.) set by the operator in advance (S20). In the case the free space is larger than the threshold, it is determined whether or not the access frequency to the image memory 12 detected by the memory access frequency detecting unit 14 is lower than the threshold set in advance by the operator or the like (for example, the time accessed per one minute is 30 seconds) (S21).

In the case it is determined in S21 that the access frequency to the image memory 12 is larger than the threshold, and in the case it is determined in S20 that the remaining capacity of the image memory 12 is lower than the threshold, the standard format image data is formed from the original format image data (S22). Then, it is determined whether or not there is the request for the delivery confirmation in accordance with the information that is stored in S3 (S23). In the case it is determined that there is the request for the delivery confirmation, the transmission is carried out under the communication mode 2 (S24). In the case it is determined that there is no request for the delivery confirmation, the transmission is carried out under the communication mode 1 (S25).

In the case it is determined in S21 that the access frequency to the image memory 12 is lower than the threshold, the standard format image data is formed from the original format image data (S26), and the transmission is carried out under the communication mode 3 (S27).

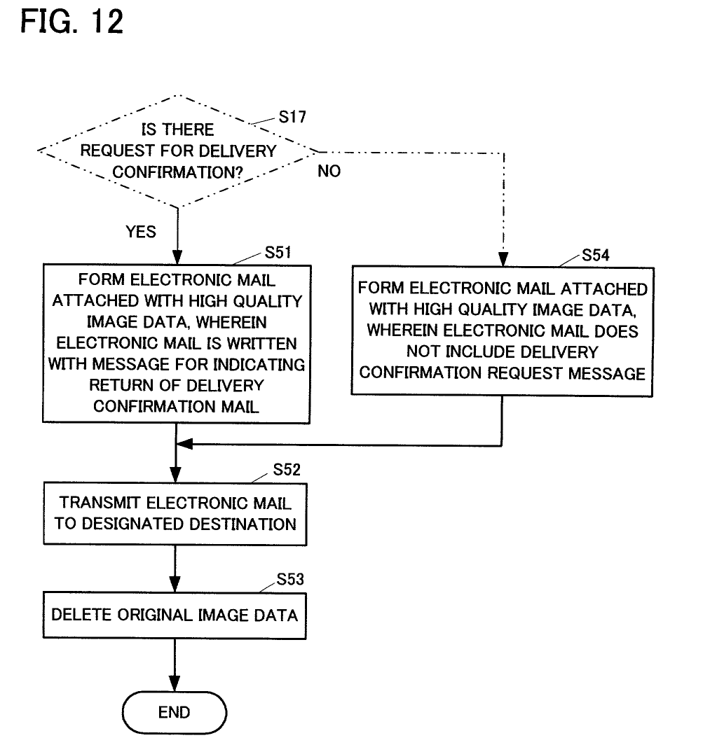

The operation in S18, S19, S24, S25, S27, will now be described in further detail. For the transmission that is to be carried out under the communication mode 4 in S18, as shown in FIG. 12, the electronic mail is formed wherein the high quality image data 18A formed in S16 is attached to the electronic mail that is written with the message 19 for requesting the return of the delivery confirmation mail as shown in FIG. 4(b) (S51). Then, the electronic mail is transmitted to the designated destination (S52), and lastly, the original image data being held is deleted (S53).

For the transmission that is to be carried out under the communication mode 5 in S19, as shown in FIG. 12, the electronic mail is formed wherein the high quality image data 18A formed in S16 is attached to the electronic mail not including the message 19 for requesting the return of the delivery confirmation mail as shown in FIG. 4(a) (S54). The electronic mail is transmitted to the designated destination (S52), and lastly, the original image data being held is deleted (S53).

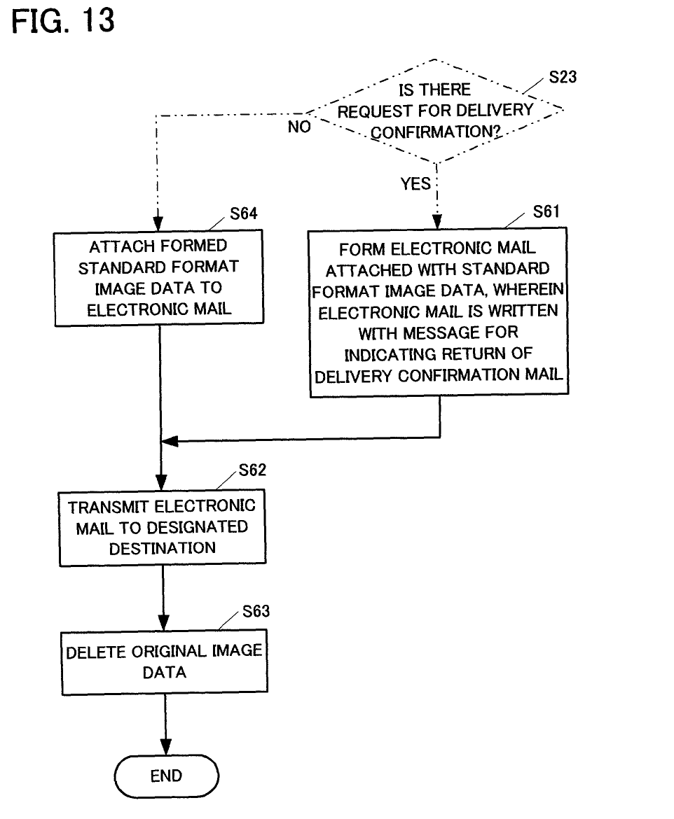

For the transmission that is to be carried out under the communication mode 2 in S24, as shown in FIG. 13, the electronic mail is formed wherein the standard format image data formed in S22 is attached to the electronic mail that is written with the message 19 for requesting the return of the delivery confirmation mail as shown in FIG. 4(b) (S61). The electronic mail is transmitted to the designated destination (S62), and lastly, the original image data being held is deleted (S63).

For the transmission that is to be carried out under the communication mode 1 in S25, as shown in FIG. 13, the standard format image data formed in S22 is attached to the electronic mail (S64), the electronic mail is transmitted to the designated destination (S62), and lastly, the original image data being held is deleted (S63).

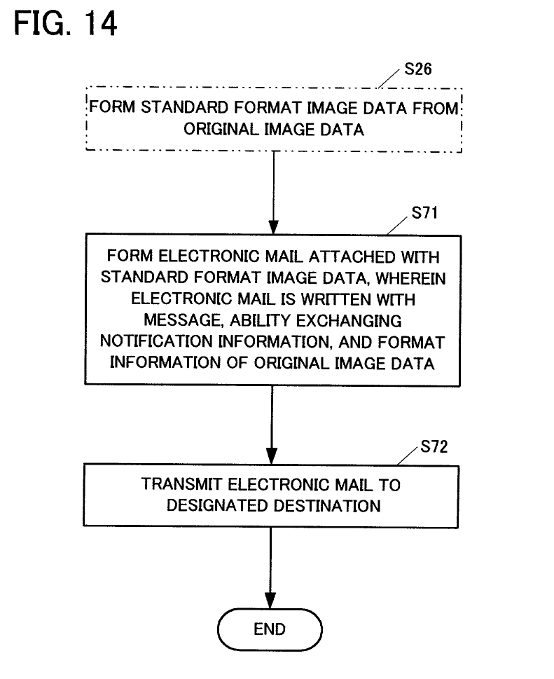

For the transmission that is to be carried out under the communication mode 3 in S27, as shown in FIG. 14, the electronic mail M1 is formed wherein the standard format image data 18 formed in S26 is attached to the electronic mail as shown in FIG. 5 that is written with the message 19 for requesting the return of the delivery confirmation mail, the ability exchanging notification information 20, and the original image data format information 21 (S71). Then, the electronic mail is transmitted to the designated destination (S72).

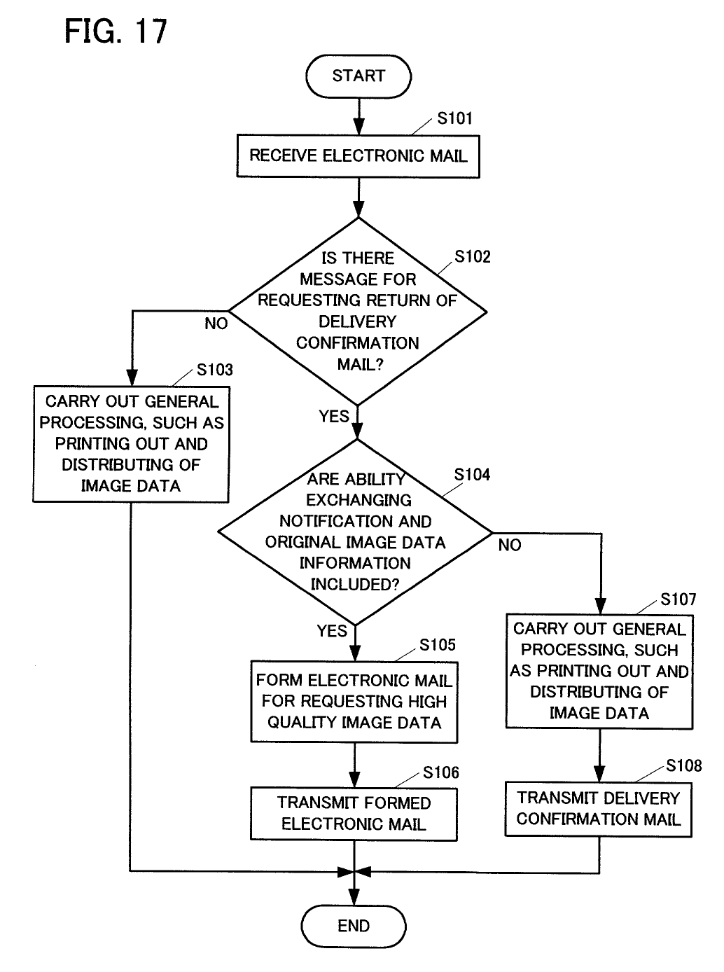

Next, the operation of when the electronic mail is received by the Internet facsimile machine of the receiving side 1B that is provided with the ability exchanging function capable of handling either one of “communication modes 1 through 5”, will be described in accordance with the flow chart shown in FIG. 17. Further, the operation to be described in accordance with the flow chart is carried out by following the command that is generated by the CPU 2 in accordance with the control program or the like that is stored in the ROM 4 of the Internet facsimile machine of the receiving side 1B.

When the Internet facsimile machine of the receiving side 1B receives the electronic mail, and as a result of analyzing the contents of the electronic mail, in the case the received electronic mail is the Internet facsimile (S101), it is determined whether or not the message 19 for requesting the return of the delivery confirmation mail as shown in the electronic mail M1 shown in FIG. 5, is included in the received electronic mail (S102). In the case it is determined that the message 19 is not included in the received electronic mail, the communication is assumed to be the “communication mode 1” or the “communication mode 5”, and the normal processing is carried out such as printing and distributing of the received image data (S103).

In the case it is determined that the message 19 is included in the received electronic mail in S102, it is determined next whether or not the ability exchanging notification information 20 and the original image data format information 21, as shown in the electronic mail M1 of FIG. 5, is included in the received electronic mail (S104). In the case it is determined that the ability exchanging notification information 20 and the original image data format information 21 are included in the received electronic mail, the communication is assumed to be the “communication mode 3”, and then, the electronic mail M2 is formed for requesting the image data higher in its quality than the standard format as shown in FIG. 6 (S105), and the formed electronic mail is transmitted (S106).

By describing the contents of the electronic mail M2 in a further detail, the e-mail address of the Internet facsimile machine of the transmitting side 1A is written in a destination designation column 33 as the destination, information 34 comprehensible by man is written in the main text column, and a machine scanning information 35 in relation with the Internet facsimile machine of the transmitting side 1A is also written in the main text column. The machine scanning information 35 includes the original message ID column 25 that is written with the message ID designated in the message ID column 24 of the electronic mail M1 or the like that is received in advance, and the receiving ability information 22 of the Internet facsimile machine of the receiving side 1B. Therefore, when receiving the electronic mail M2, the Internet facsimile machine of the transmitting side 1A determines that the received electronic mail M2 is the response to the electronic mail M1 that is received in advance, in accordance with the original message ID written in the original message ID column 25. Then, the transmission is carried out under the “communication mode 3”.

Next, in the case it is determined in S104 that the ability exchanging notification information 20 is not included, the Internet facsimile machine of the receiving side 1B carries out the normal processing such as printing and distributing of the received image data (S107). The communication is assumed to be the “communication mode 2” or the “communication mode 4”, the delivery confirmation mail is formed and transmitted to the Internet facsimile machine of the transmitting side 1A (S108).

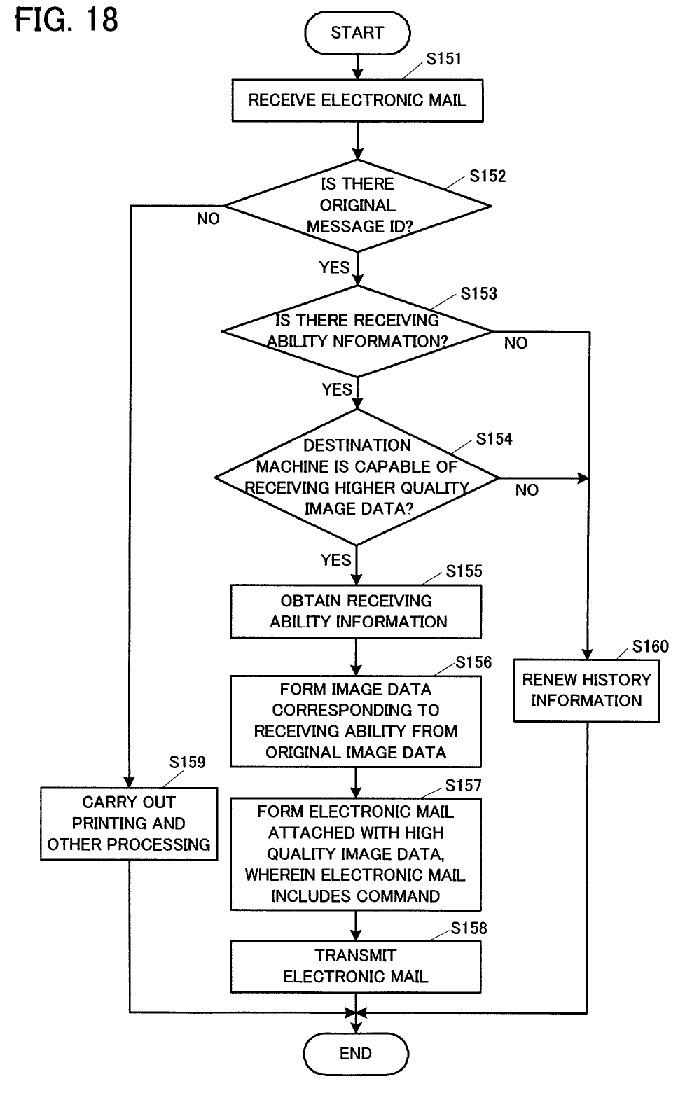

Next, the operation of when the Internet facsimile machine of the transmitting side 1A receives the electronic mail that is transmitted by the Internet facsimile machine of the receiving side 1B in S106 will be described in accordance with the flow chart shown in FIG. 18. Further, the operation to be described in accordance with the flow chart is also carried out by following the command that is generated by the CPU 2 in accordance with the control program or the like that is stored in the ROM 4 of the Internet facsimile machine of the transmitting side 1A.

When the Internet facsimile machine of the transmitting side 1A receives the electronic mail, and as a result of analyzing the contents of the received electronic mail, in the case the received electronic mail is the Internet facsimile (S151), it is determined whether or not the received electronic mail is the response to the electronic mail M1 that is transmitted in advance, in accordance with whether or not the original message ID of the electronic mail M1 transmitted in advance is included in the original message ID column 25 (S152). In the case the original message ID is included, it is determined whether or not the receiving ability information 22 is included in the machine scanning information 35 (S153).

In the case it is determined that the receiving ability information 22 is included, next, it is determined whether or not the destination machine is capable of receiving the image data higher in its quality than the standard format image data from the written receiving ability information (S154). In other words, in the case the resolution that can be received and processed by the destination machine is higher than the resolution of the standard format “200 dpi”, it is determined that the “image data higher in its quality than the standard format image data can be received”, in accordance with the receiving ability information. In the case only the encoding method of the destination machine differs, or in the case only the printable recording paper size differs, such a determination is not made.

In the case it is determined in S154 that the destination machine is capable of receiving the image data higher in its quality than the standard format image data, the receiving ability information 22 is obtained (S155), and the image data (high quality image data) of the format corresponding to the receiving ability information 22 is formed from the original image data (S156). Then, the electronic mail is formed, wherein the high quality image data 18A is attached to the electronic mail that includes the message 19 for requesting the notification of the delivery confirmation, likewise as the electronic mail M3 shown in FIG. 7 (S157), and the electronic mail is transmitted to the Internet facsimile machine of the receiving side 1B (S158).

In the case it is determined in S152 that the original message ID is not included, the received electronic mail is assumed to be the normal electronic mail, and the printing and other processing are carried out (S159).

Meanwhile, in the case it is determined in S153 that the receiving ability information 22 is not included, and in the case it is determined in S154 that the destination machine is unable to receive the image data higher in its quality than the standard format image data, the received electronic mail is assumed to be the delivery confirmation mail, and a transmission history information is renewed (S160).

When the Internet facsimile machine of the receiving side 1B receives the electronic mail M3 transmitted in S158, the Internet facsimile machine of the receiving side 1B operates according to the flow chart shown in FIG. 17, by the command generated by the CPU 2 in accordance with the control program or the like that is stored in the ROM 4. In other words, when receiving the electronic mail M3 (S101) that is written with the message 19 for requesting the return of the delivery confirmation mail, and not written with the ability exchanging notification information 20, it is determined that there is the message 19 (S102), and also it is determined that the ability exchanging notification information is not included in the electronic mail (S104). Then, the normal processing such as printing and distributing of the image data is carried out (S107). Lastly, the message ID of the received electronic mail M3 is written into the original message ID column 25, and the delivery confirmation mail (electronic mail) M4 written with the processing completion message 23 showing the fact that the electronic mail M3 is received and processed, is returned to the Internet facsimile machine of the transmitting side 1A (S108).

Meanwhile, the Internet facsimile machine of the transmitting side 1A that received the reply of the delivery confirmation mail M4 operates by following the flow chart shown in FIG. 18. In other words, the delivery confirmation mail M4 is received (S151), the delivery confirmation mail M4 is determined to be the response to the electronic mail M3 transmitted in advance according to the original message ID written in the original message ID column 25. Then, since the receiving ability information is not written, it proceeds to S160, the information that the high quality image data is received and processed by the Internet facsimile machine of the receiving side 1B is obtained from the processing end message 23 of the delivery confirmation mail M4, and the transmission history information is renewed.

The Internet facsimile machine according to the second embodiment of the present invention will now be described in accordance with the drawings. The structure of the Internet facsimile machine is the same as the Internet facsimile machine of the first embodiment.

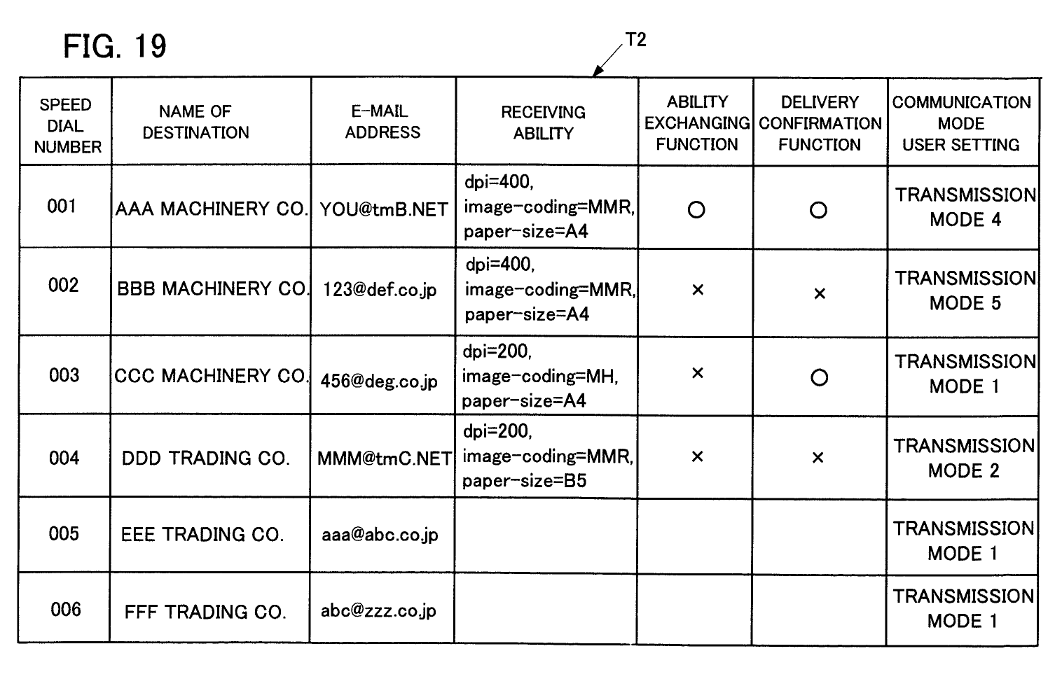

According to the second embodiment, a data table T2 shown in FIG. 19 is stored in the prescribed storing field in the RAM 3 of the Internet facsimile machine of the transmitting side 1A. The data table T2 stores the e-mail address (destination information) that are assigned and registered for each speed dial number by the operator, and the information concerning the destination machine that is stored in association with the e-mail address. By describing the specific contents, the data table T2 includes “speed dial number” column, “name of destination” column, “e-mail address” column, “receiving ability” column, “ability exchanging function” column, “delivery confirmation function” column, and “communication mode—user setting” column. Various information is stored in each column per each of the speed dial numbers that is registered in the “speed dial number” column. The information stored in each column can be set and obtained by the operation of the operator from the operating unit 10 or the client PC to be described later on.

In the “name of destination” column in the data table T2, the information concerning the name of the destination, such as the name or the company name of the destination, are stored. The data table T2 is referred to when transmitting from the speed dial number, and the name of the destination is displayed on the display 10a or the like. In the “e-mail address” column, the e-mail address as the destination information is stored, and when the speed dial number is designated at the transmission, the e-mail address stored in the “e-mail address” column is designated as the destination of the transmission.

In the “receiving ability” column, the “ability exchanging function” column, and the “delivery confirmation function” column, the information concerning the function of the destination machine (function information of the destination machine) is stored. In the “receiving ability” column, for example, the information concerning the resolution that can be received and processed by the destination machine is written after “dpi=”, the information concerning the encoding method of the destination machine is written after “image-coding=”, and the information concerning the printable recording paper size of the destination machine is written after “paper-size=”. The “ability exchanging function” column stores the information concerning whether or not the destination machine is provided with the ability exchanging function, which is to be described later on. The “delivery confirmation function” column stores the information concerning whether or not the destination machine is provided with the delivery confirmation function, which is to be described later on. The “communication mode.user setting” column stores the information concerning the communication mode of when transmitting to each destination. Further, in the case the communication mode is not set by the operator, in the “communication mode.user setting” column, the “communication mode 1” is to be stored as a default value. For the communication mode, it is the same as in the first embodiment.

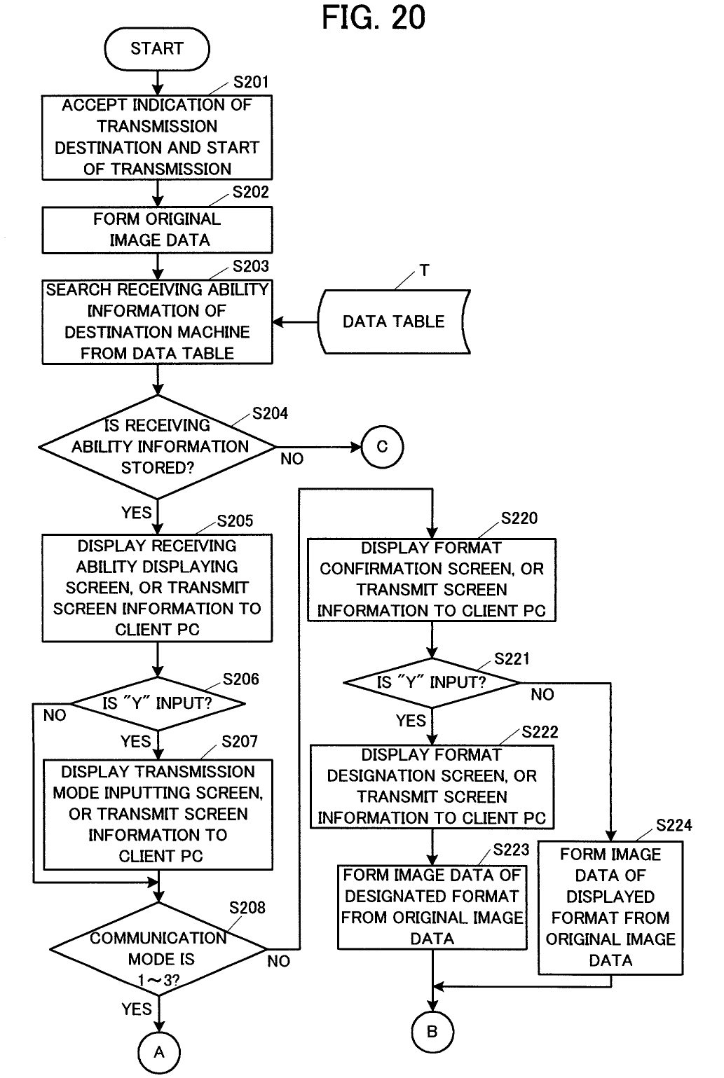

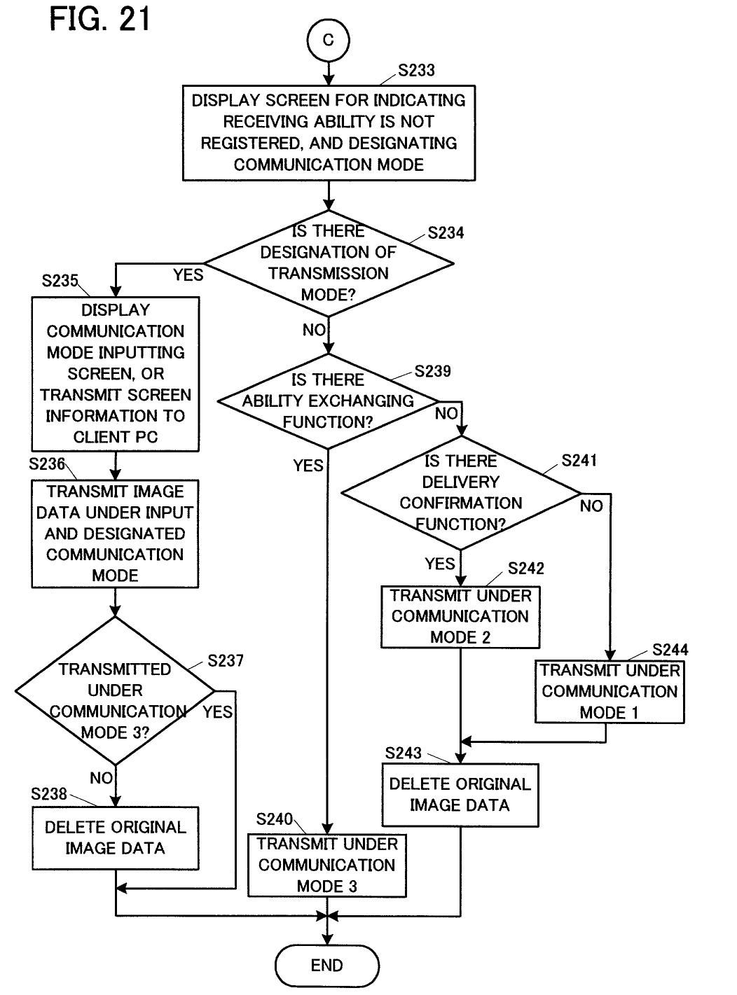

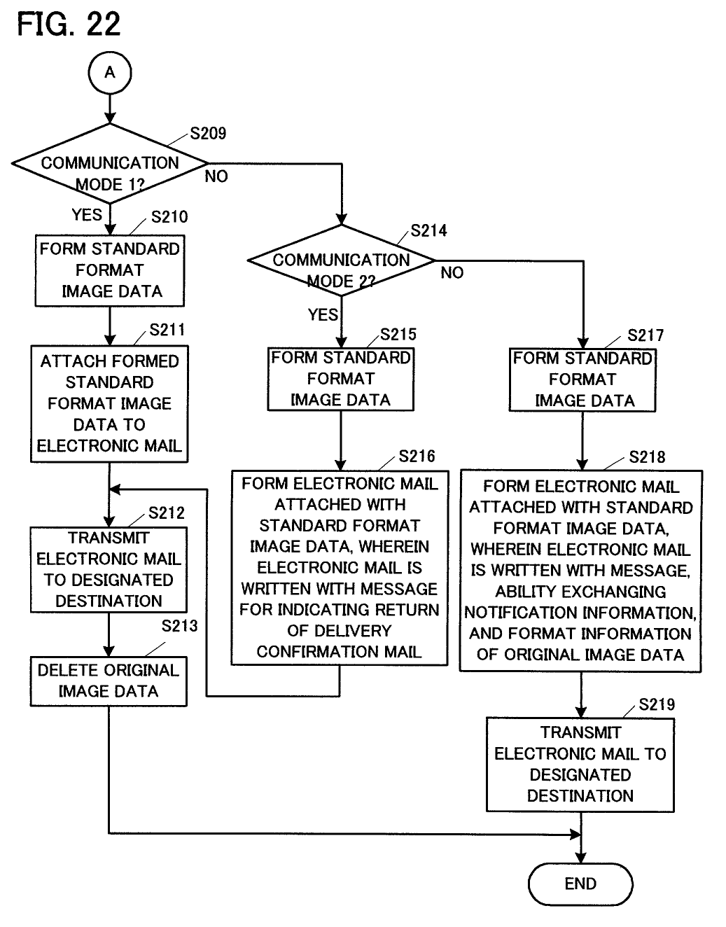

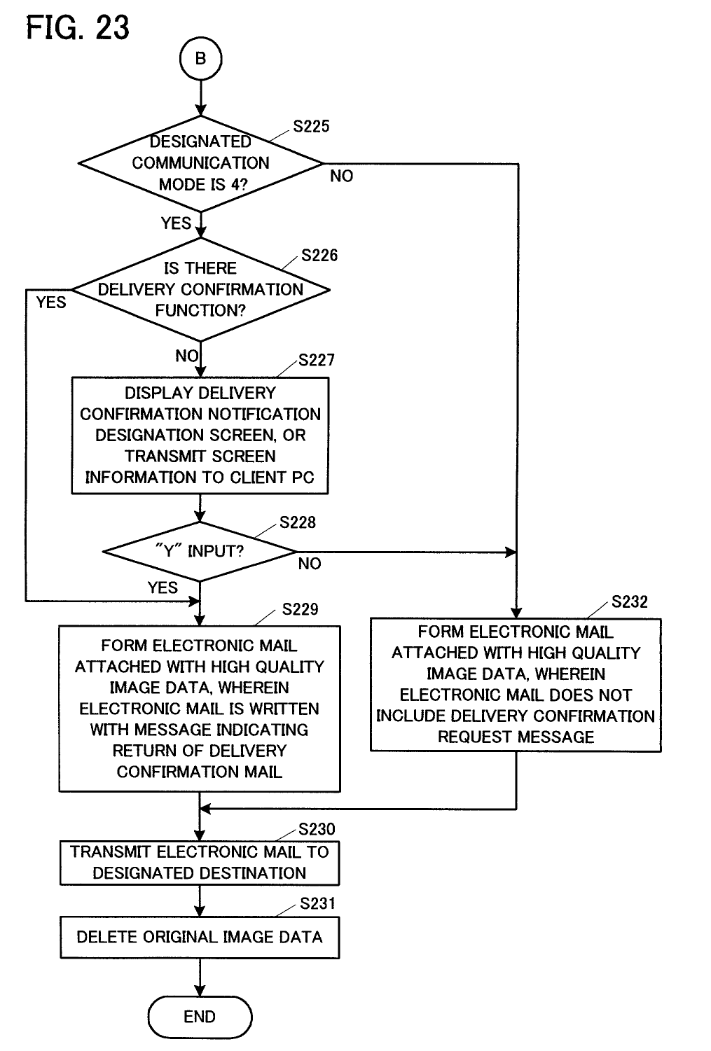

Next, the operation of the Internet facsimile machine of the transmitting side 1A that is provided in the network environment (A) as shown in FIG. 9, of when transmitting the image data formed by the original being scanned from the scanner 8, or the image data received from the client PC 27 to be transmitted by the facsimile, will be described in accordance with the flow charts shown in FIG. 20 through FIG. 23. Further, the operation to be described in accordance with the flow charts is carried out by following the command generated by the CPU 2 in accordance with the control program or the like that is stored in the ROM 4 of the Internet facsimile machine of the transmitting side 1A.

First, when the indication is made for the transmission destination or the start of the transmission of the image data by the operation from the operating unit 10 or the client PC 27 by the operator, as shown in the flow chart of FIG. 20, the Internet facsimile machine of the transmitting side 1A accepts this indication (S201), forms the original image data by scanning the original (S202), and searches the receiving ability information of the designated destination machine from the data table T2 (S203). In the case the destination is designated by the speed dial number, the receiving ability information stored in the “receiving ability” column is searched in the data table T2 for the corresponding speed dial number. In the case the destination is designated by the input from the operating unit 10 or the client PC 27, without using the speed dial number, the “e-mail address” column is searched in the data table T2 for the input and designated destination. When there is a corresponding e-mail address, the receiving ability information stored in the “receiving ability” column is searched for such an e-mail address.

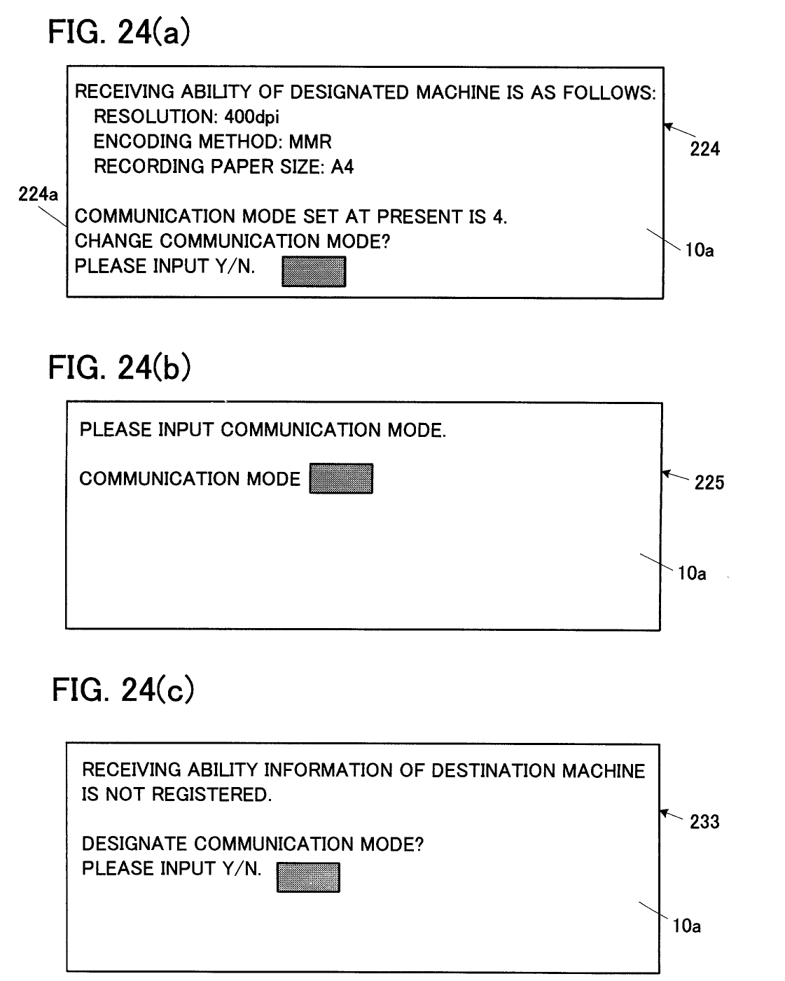

As a result of the searching, in the case the receiving ability information is stored in the “receiving ability” column in the data table T2 (S204), in accordance with the receiving ability information, the receiving ability displaying screen 224 for displaying the receiving ability of the destination machine, as shown in FIG. 24(a), is displayed on the display 10a, or the receiving ability displaying screen 224 is to be displayed on the displaying device of the client PC 27 by transmitting the screen information of the receiving ability displaying screen 224 to the client PC 27 (S205). Moreover, a display 224a is also carried out at the same time for demanding the operator to confirm the communication mode that is stored in the “communication mode.user setting” column in the data table T2. By inputting “Y” or “N” from the operating unit 10 or the like, the operator is capable of selecting whether to transmit under the communication mode that is set in advance, or to change the communication mode.

Further, the format of the image data that is displayed on the receiving ability displaying screen 224 is displayed in accordance with the receiving ability information that is stored in the “receiving ability” column for the destination information in the data table T2. For example, the resolution “400 dpi” of the image data shown in the “resolution” column is displayed in accordance with the information designated after “dpi=” and in front of “,” in the receiving ability information in the data table T2, the encoding method “MMR” of the image data shown in the “encoding method” column is displayed in accordance with the information shown after “image-coding=” and in front of “,” in the receiving ability information, and “A4” showing the recording paper size that is shown in the “recording paper size” column is displayed in accordance with the information designated after the “paper-size=” of the receiving ability information.

In the case “Y” or “N” is input by the operator from the displayed receiving ability displaying screen 224 in S205, it is determined whether or not the input is “Y” (S206). In the case “Y” is input, the communication mode inputting screen 225 shown in FIG. 24(b) is displayed on the display 10a, or the communication mode inputting screen 225 is to be displayed on the displaying device of the client PC 27 by transmitting the screen information of the communication mode inputting screen 225 to the client PC 27 (S207).

Next, in the case it is determined in S206 that “Y” is not input (“N” is input), and in the case the communication mode is input and designated from the screen 225 by the operator in S207, it is determined whether or not the input and designated communication mode is any one of the communication modes 1 through 3 (S208).

In the case it is determined that the designated communication mode is 1 (S209), the standard format image data is formed from the original image data (S210), the standard format image data is attached to the electronic mail (S211), the electronic mail is transmitted to designated destination (S212), and the original image data being held is deleted (S213).

In the case it is determined that the designated communication mode is 2 (S214), the standard format image data is formed from the original image data (S215), the electronic mail is formed wherein the standard format image data formed in S215 is attached to the electronic mail which is written with the message 19 for requesting the return of the delivery confirmation mail as shown in FIG. 4(b) (S216), the electronic mail is transmitted to the designated destination (S212), and the original image data being held is deleted (S213).

In the case it is determined in S214 that the communication mode is not 2 (the communication mode is 3), the format of the original image data is converted and the standard format image data is formed (S217). Then, the electronic mail M1 is formed, wherein the standard format image data 18 formed in S217 is attached to the electronic mail is written with the message 19 for requesting the return of the delivery confirmation mail, the ability exchanging notification information 20, and the original image data format information 21, as shown in FIG. 5 (S218). The electronic mail is transmitted to the designated destination (S219).

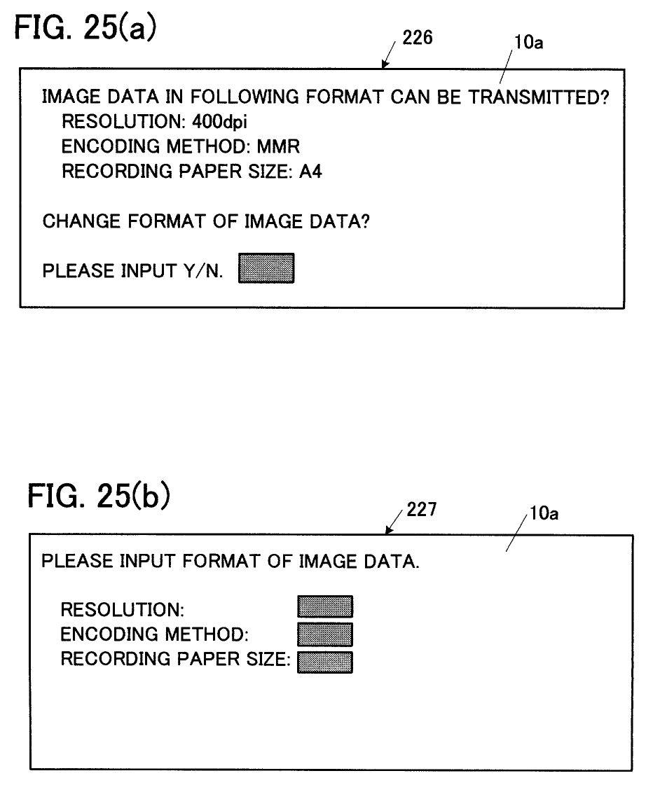

Meanwhile, in the case it is determined in S208 that the communication mode is not any one of the communication modes 1 through 3, the format confirmation screen 226 as shown in FIG. 25(a) is displayed for requesting the operator to confirm the format of the image data to be transmitted, or the format confirmation screen 226 is to be displayed on the displaying device of the client PC 27 by transmitting the screen information of the format confirmation screen 226 to the client PC 27 (S220). On the format confirmation screen 226, by requesting the operator to input “Y” or “N” concerning the format of the image data to be displayed, the intention of the operator is confirmed. Further, the format of the image data to be displayed on the format confirmation screen 226 is displayed in accordance with the receiving ability information that is stored in the “receiving ability” column for the destination information in the data table T2, as in the same manner as the receiving ability displaying screen 224 is displayed.

In the case “Y” is input on the format confirmation screen 226 as to change the communication mode that is set by the operator in advance (S221), the format designation screen 227 as shown in FIG. 25(b) is displayed on the display 10A, or the screen information of the format designation screen 227 is transmitted to the client PC 27 (S222). When the format of the image data to be transmitted is input by the operator from the format designation screen 227, the image data of the format input and designated by the operator is formed from the original image data (S223). Meanwhile, in the case “N” is input in S221 by the operator as to accept the transmission of the image data under the displayed format, the image data of the format displayed on the format confirmation screen 226 is formed from the original image data (S224).

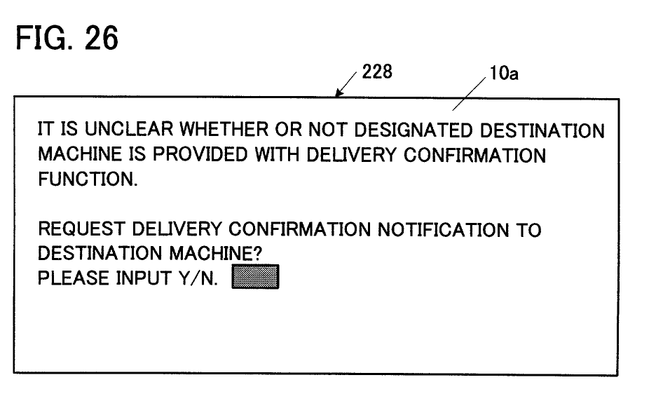

Next, it is determined whether or not the communication mode displayed in S205, and the communication mode designated on the communication mode inputting screen 225 that is displayed in S207, are the communication mode 4 (S225). In the case the communication mode is 4, it is determined whether or not the designated destination machine is provided with the delivery confirmation function, in accordance with the information stored in the “delivery confirmation function” column for the destination in the data table T2 (S226). In the case it is determined that the destination machine is not provided with the delivery confirmation function, the delivery confirmation notification designation screen 228, as shown in FIG. 26, is displayed on the display 10a for indicating that the presence or the absence of the delivery confirmation function of the destination machine cannot be confirmed and designating whether or not to request the delivery confirmation mail, or the screen information of the delivery confirmation notification designation screen 228 is transmitted to the client PC 27 (S227).

In the case it is determined in S226 that the destination machine is provided with the delivery confirmation function, and in the case “Y” is input by the operator in S228, next, the electronic mail is formed that is attached with the high quality image data 18A formed in S223 or S224, wherein the electronic mail is written with the message 19 for requesting the return of the delivery confirmation mail as shown in FIG. 4(b) (S229). Then, the electronic mail is transmitted to the designated destination (S230), and the original image data is deleted lastly (S231).

Meanwhile, in the case it is determined in S225 that the designated communication mode is not 4, and in the case it is determined that “Y” is not input in S228 (“N” is input), the electronic mail is formed of which is attached with the high quality image data formed in S223 or S224, wherein the electronic mail does not include the message 19 for requesting the return of the delivery confirmation mail as shown in FIG. 4(a) (S233). Then, the electronic mail is transmitted to the designated destination (S230), and the original image data is deleted lastly (S231).

Meanwhile, in the case it is determined in S204 that the receiving ability information of the destination machine is not registered, the screen 233 as shown in FIG. 24(c) is displayed for indicating that the receiving ability information is not registered and confirming the designation of the communication mode (S233). The confirmation for the designation of the communication mode is carried out by demanding the operator to input “Y” or “N”, and when “Y” is input by the operator as to designate the communication mode (S234), the communication mode inputting screen 225 as shown in FIG. 24(b) is displayed on the display 10a, or the communication mode inputting screen 225 is to be displayed on the displaying device of the client PC 27 by transmitting the screen information of the communication mode inputting screen 225 to the client PC 27 (S235). Then, when the communication mode is input and designated on the screen 225 by the operator, the Internet facsimile machine 1 transmits the image data under the input and designated communication mode (S236). In other words, in the case “inputting mode 1” is designated, the operation of S210 through S212 is carried out sequentially, in the case “inputting mode 2” is designated, the operation of S215, S216 and S212 is carried out sequentially, in the case “inputting mode 3” is designated, the operation of S217 through S219 is carried out sequentially, in the case “inputting mode 4” in designated, the operation of S229 through S230 is carried out sequentially, and in the case “inputting mode 5” is designated, the operation of S232, S230 is carried out sequentially.

Next, only in the case the image data is transmitted in S236 under the communication mode other than the “communication mode 3” (S237), the original image data being held is deleted (S238).

In the case it is determined in S234 that “Y” is not input (“N” is input), it is determined whether or not the destination machine is provided with the ability exchanging function, in accordance with the information stored in the “ability exchanging function” column in the data table T2 for the destination (S239). In the case it is determined that the destination machine is provided with the ability exchanging function, the transmission is carried out under the “communication mode 3” (S240). In the case it is determined that the destination machine is not provided with the ability exchanging function, it is determined next whether or not the destination is provided with the delivery confirmation function, in accordance with the information stored in the “delivery confirmation function” column in the data table T2 for the destination (S241). Then, in the case it is determined that the destination machine is provided with the delivery confirmation function, the transmission is carried out under the “communication mode 2” (S242), and the original image data being held is deleted (S243). Meanwhile, in the case it is determined in S241 that the destination machine is not provided with the delivery confirmation function, the transmission is carried out under the “communication mode 1” (S244), and the original image data being held is deleted (S243).

Next, the Internet facsimile machine according to the third embodiment of the present invention will be described in accordance with the drawings. The structure of the Internet facsimile machine is the same as in the first embodiment.

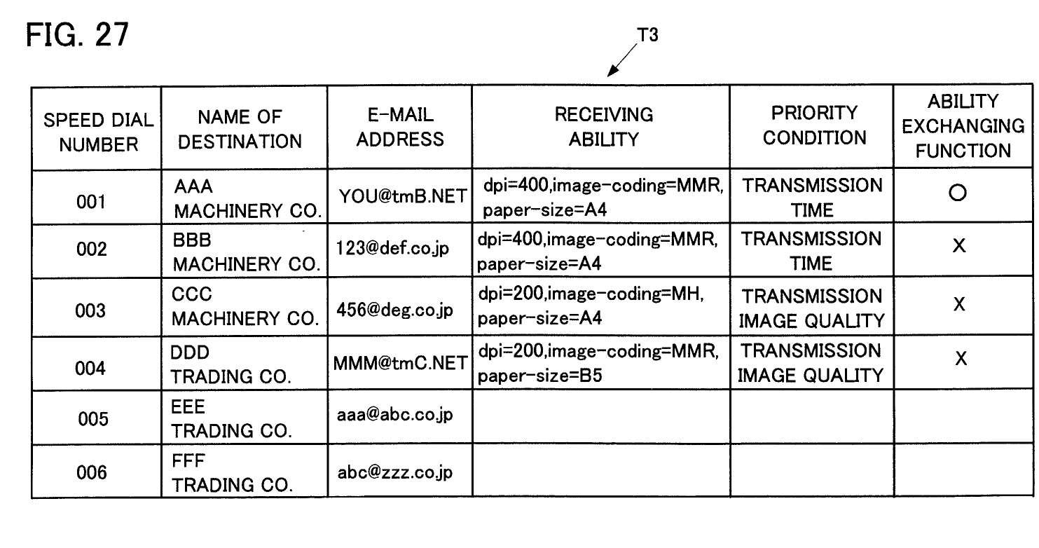

According to the third embodiment, a data table T3 shown in FIG. 27 is stored in the prescribed storing field in the RAM 3 of the Internet facsimile machine of the transmitting side 1A. The data table T3 stores the e-mail address (destination information) assigned and registered for each speed dial numbers by the operator, and stores the information concerning the destination machine that is memorized in association with the e-mail address. By describing for the specific contents, the data table T3 includes “speed dial number” column, “name of destination” column, “e-mail address” column, “receiving ability” column, “ability exchanging function” column, and “priority condition” column. Various information is stored in each column for each of the speed dial numbers registered in the “speed dial number” column, and the information stored in each column is to be set and obtained by the operation of the operator from the operating unit 10 or a client PC to be described later on.

In the “name of destination” column in the data table T3, the information concerning the name of the destination, such as the name or the company name of the destination, are stored. The data table T3 is referred to when transmitting from the speed dial number, and the name of the destination is to be displayed on the display 10a or the like. In the “e-mail address” column, the e-mail address as the destination information is stored, and when the speed dial number is designated at the transmission, the e-mail address stored in the “e-mail address” column is designated as the destination of the transmission.

In the “receiving ability” column, for example, the information concerning a resolution that can be received and processed by the destination machine is written after “dpi=”, the information concerning the encoding method of the destination machine is written after “image-coding=”, and the information concerning the printable recording paper size of the destination machine is written after “paper-size=”. The “ability exchanging function” column stores the information concerning whether or not the destination machine is provided with an ability exchanging function to be described later on. The “priority condition” column stores the information for designating whether to transmit by giving priority to the image quality of the original, or to transmit by giving priority to the transmission time. Further, a column (not shown in the drawings) can be provided for storing as the information for designating the communication mode, the information for designating any one of five types of communication modes, the “communication mode 1” through the “communication mode 5”, and the Internet facsimile machine of the transmitting side 1A can refer to the information stored in the column at the transmission. Moreover, for example, as in S302 to be described later on, instead of accepting the designation of the priority condition, the designation of either communication mode can be made to be accepted, and the transmission can be carried out under the designated communication mode. For the communication mode, it is the same as in the first embodiment.

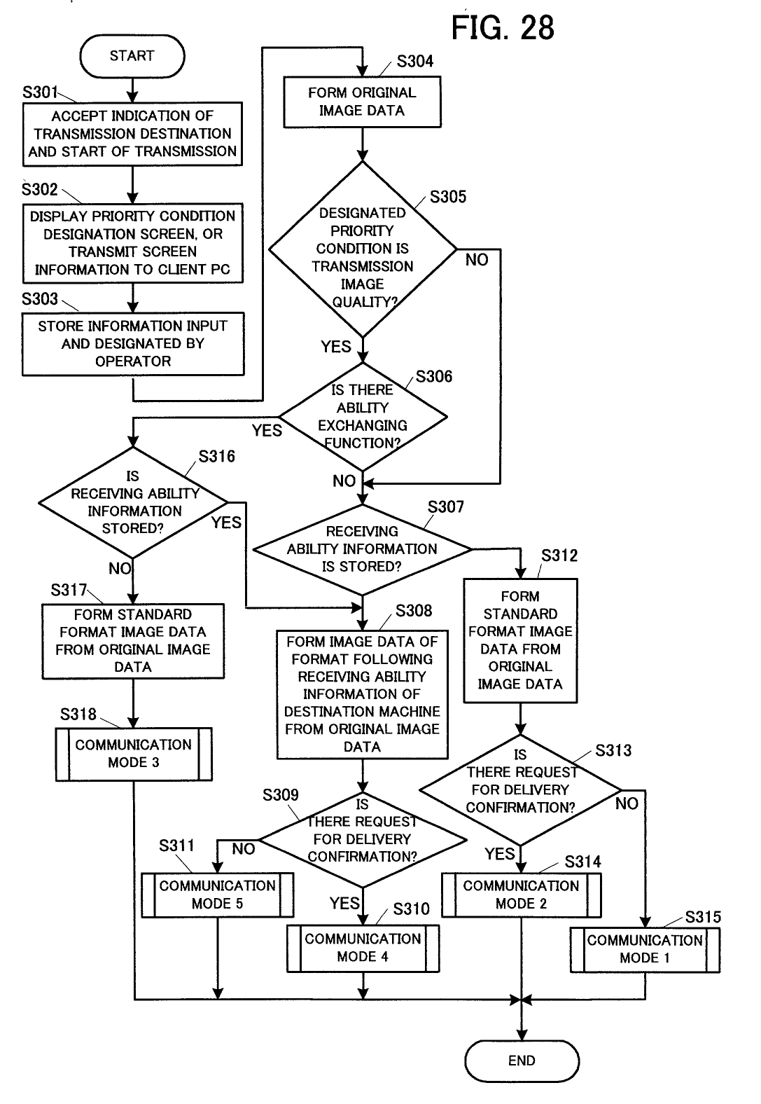

Next, the operation of the Internet facsimile machine of the transmitting side 1A that is provided in the network environment (A) as shown in FIG. 9, when transmitting the image data formed by the original being scanned from the scanner 8, or the image data received from the client PC 27 for the facsimile transmission, will be described in accordance with the flow charts shown in FIG. 28 through FIG. 31. Further, the operation to be described in accordance with the flow charts is carried out by following the command generated by the CPU 2 in accordance with the control program or the like that is stored in the ROM 4 of the Internet facsimile machine of the transmitting side 1A.

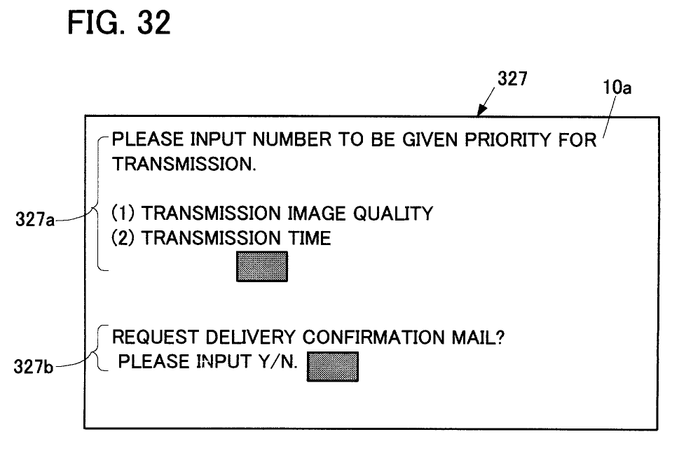

First, when the indication for the transmission destination or the start of the transmission is made for the image data by the operation by the operator from the operating unit 10 or the client PC 27, as shown in the flow chart of FIG. 28, the Internet facsimile machine of the transmitting side 1A accepts the indication (S301). Then, the priority condition designation screen 327 is displayed on the display 10a, or the screen information of the priority condition designation screen 327 is transmitted to the client PC 327 (S302). The priority condition designation screen 327 shown in FIG. 32 as an example, accepts from the outside, the designation of the priority condition for giving priority to either the transmission image quality or the transmission time for the transmission, by the inputting operation or the like of the operator. Moreover, the priority condition designation screen 327 includes a priority condition designation column 327a, and a delivery confirmation mail designation column 327b that designates whether or not to request the return of the delivery confirmation mail. When “1” or “2” is input and designated by the operator from the screen 327 as to give priority to the transmission image quality or the transmission time, and when “Y” or “N” is input and designated by the operator as to designate whether or not to request the delivery confirmation mail, the input and designated information is stored into the prescribed storing field in the RAM 3 (S303). Then, the original is scanned to form the original image data (S304).

Next, it is determined whether or not the priority condition designated by the operator is giving priority to the transmission image quality, in accordance with the information stored in S303, or the information stored in the “priority condition” column in the data table T3 (S305). In the case the designated priority condition is for the transmission image quality, it is determined whether or not the destination machine is provided with the ability exchanging function, in accordance with the information stored in the “ability exchanging function” column in the data table T3 (S306). In the case it is determined that the destination machine is not provided with the ability exchanging function, and in the case it is determined in S305 that the designated priority condition is not the transmission image quality, next, it is determined whether or not the receiving ability information for the destination is stored in the “receiving ability” column in the data table T3 (S307). In the case the receiving ability information is stored, the image data of the format (high quality image data) following the receiving ability information of the destination that is stored in the “receiving ability” column in the data table T3, is formed from the original image data (S308). Then, it is determined whether or not there was the request for the delivery confirmation in accordance with the information stored in S303 (S309). In the case it is determined that there was the request for the delivery confirmation, the transmission is carried out under the communication mode 4 (S310). In the case it is determined there was no request for the delivery confirmation, the transmission is carried out under the communication mode 5 (S311).

In the case it is determined in S307 that the receiving ability information of the destination machine is not stored in the data table T3, the standard format image data is formed from the original format image data (S312), and it is determined whether or not there was the request for the delivery confirmation in accordance with the information stored in S303 (S313). In the case it is determined that there was the request for the delivery confirmation, the transmission is carried out under the communication mode 2 (S314). In the case it is determined that there was no request for the delivery confirmation, the transmission is carried out under the communication mode 1 (S315).

Meanwhile, in the case it is determined in S306 that the destination machine is not provided with the ability exchanging function, it is determined whether or not the receiving ability information for the destination is stored in the “receiving ability” column in the data table T3 (S316). In the case the receiving ability information is stored, it proceeds to S308, and the transmission is carried out under the communication mode 4 or the communication mode 5. In the case it is determined that the receiving ability information is not stored, the standard format image data is formed from the original format image data (S317), and the transmission is carried out under the communication mode 3 (S318).

Further, the determining step in S316 is provided for shortening the transmission time when the transmission image quality is given with priority and the receiving ability information of the destination machine is stored in the table T3. However, when giving priority only to the transmission image quality, and the transmission time is not considered, the determining step in S316 can be abbreviated, and S317 can be carried out after “YES” in S306.

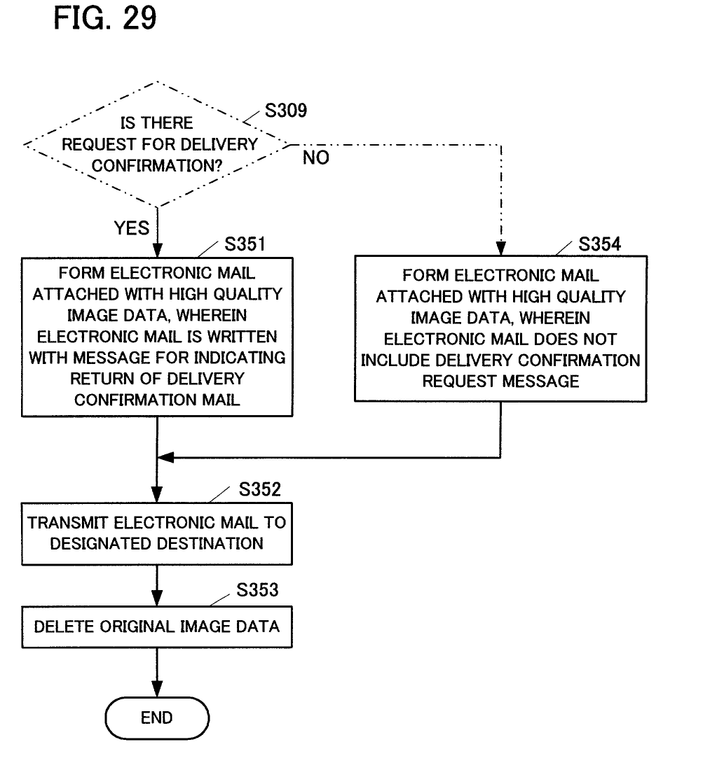

The operation in S310, S311, S314, S315, S318, will be described in further detail. For the transmission to be carried out under the communication mode 4 in S310, as shown in FIG. 29, the electronic mail is formed that is attached with the high quality image data 18A formed in S308, wherein the electronic mail is written with the message 19 for requesting the return of the delivery confirmation mail as shown in FIG. 4(b) (S351). Then, the electronic mail is transmitted to the designated destination (S352), and the original image data being held is deleted lastly (S353).

For the transmission to be carried out under the communication mode 5 in S311, as shown in FIG. 29, the electronic mail is formed that is attached with the high quality image data 18A formed in S308, wherein the electronic mail does not include the message 19 for requesting the return of the delivery confirmation mail as shown in FIG. 4(a) (S354). Then, the electronic mail is transmitted to the designated destination (S352), and the original image data being held is deleted lastly (S353).

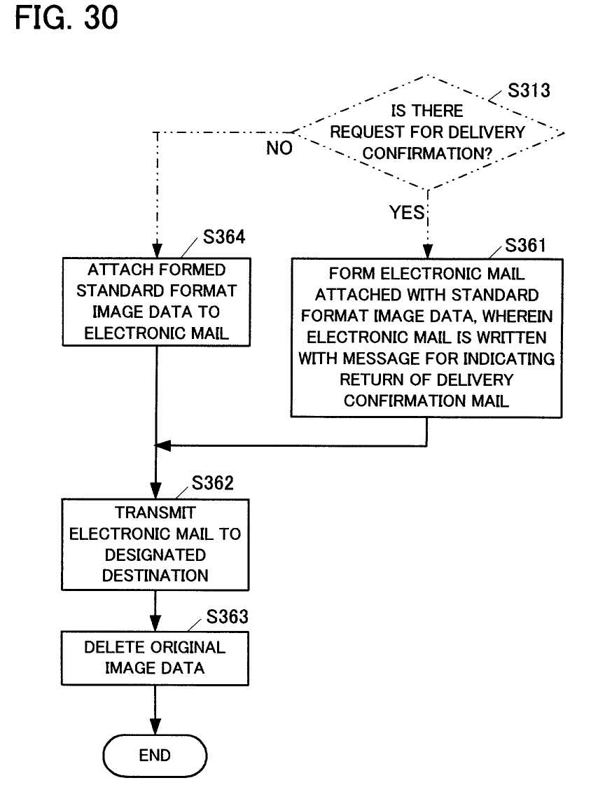

For the transmission to be carried out under the communication mode 2 in S314, as shown in FIG. 30, the electronic mail is formed that is attached with the standard format image data formed in S312, wherein the electronic mail is written with the message 19 for requesting the return of the delivery confirmation mail as shown in FIG. 4(b) (S361). Then, the electronic mail is transmitted to the designated destination (S362), and the original image data being held is deleted lastly (S363).

For the transmission to be carried out under the communication mode 1 in S315, as shown in FIG. 30, the standard format image data formed in S312 is attached to the electronic mail (S364), the electronic mail is transmitted to the designated destination (S362), and the original image data being held is deleted lastly (S363).

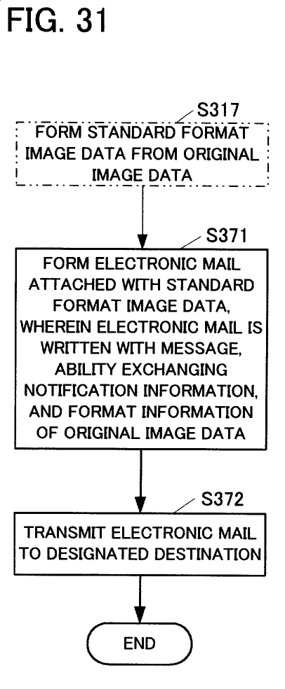

For the transmission to be carried out under the communication mode 3 in S318, as shown in FIG. 31, the electronic mail M1 is formed that is attached with the standard format image data 18 formed in S317, wherein the electronic mail is written with the message 19 for requesting the return of the delivery confirmation mail, the ability exchanging notification information 20, and the original image data format information 21, as shown in FIG. 5 (S371). Then, the electronic mail is transmitted to the designated destination (S372).

What is claimed is:

1. An Internet facsimile machine comprising:
a processor having an ability exchanging function for forming an electronic mail including standard format image data and format information of original image data, transmitting the electronic mail, receiving an electronic mail having machine receiving ability information and transmitting the image data formed in accordance with the machine receiving ability information from the original image data; and
a controller for determining whether or not to use the ability exchanging function for the transmission of the image data in accordance with a state of the Internet facsimile machine when transmitting the image data.

2. The Internet facsimile machine according to claim 1, wherein the state of the machine is an amount of memory available for storing image data.

3. The Internet facsimile machine according to claim 1, wherein the state of the machine is a frequency in use per time of memory.

4. The Internet facsimile machine according to claim 1 comprising:
a machine receiving ability storage device for storing the machine receiving ability information of a receiving device;
wherein in case the machine receiving ability information of the receiving device is previously stored in the machine receiving ability storage device, the image data formed in accordance with the previously stored machine receiving ability information, is transmitted without using the ability exchanging function.

5. An Internet facsimile machine connected to a network, comprising:
a processor having an ability exchanging function for forming an electronic mail including standard format image data and format information of original image data, transmitting the electronic mail, receiving an electronic mail having machine receiving ability information and transmitting the image data formed from the original image data in accordance with the machine receiving ability information; and
a controller for determining whether or not to use the ability exchanging function for the transmission of the image data in accordance with a communication state of the network when transmitting the image data.

6. An Internet facsimile machine comprising:
a function for forming an electronic mail including standard format image data and format information of original image data, transmitting the electronic mail, receiving an electronic mail having machine receiving ability information and transmitting the image data formed from the original image data in accordance with the machine receiving ability information;
a destination function information storing unit for previously storing the function information of a receiving device; and
a destination function information display unit for displaying the previously stored function information of the receiving device at the time of transmission.

7. The Internet facsimile machine according to claim 6 wherein the displaying of the function information of the receiving device is carried out on a display.

8. An Internet facsimile machine comprising:
a function for forming an electronic mail including standard format image data and format information of original image data, transmitting the electronic mail, receiving an electronic mail having machine receiving ability information, and transmitting the image data formed from the original image data in accordance with the machine receiving ability information;
a destination function information storing unit for previously storing the function information of a receiving device; and
a transmission unit for transmitting the function information of the receiving device to other terminal devices connected through a network at the time of transmission.

9. An Internet facsimile machine comprising:
a processor having an ability exchanging for forming an electronic mail including standard format image data and format information of original image data, transmitting the electronic mail, receiving an electronic mail having machine receiving ability information, and transmitting the image data formed from the original image data in accordance with the machine receiving ability information;
a processor having a priority condition designating function for accepting from outside, the designation for whether to give priority to either transmission image quality or transmission time, for the transmission of the image data; and
a processor for selecting either one of transmission by a single electronic mail, or transmission by a plurality of electronic mails using the ability exchanging function, as the transmission method of the image data in accordance with the priority condition designated through the priority condition designating function.

10. The Internet facsimile machine according to claim 9 wherein the processor for selecting selects transmission by the plurality of electronic mails using the ability exchanging function when the priority condition designated through the priority condition designating function is the transmission image quality, and selects the transmission by a single electronic mail when the designated priority condition is the transmission time.

11. The Internet facsimile machine according to claim 9 further comprising:
a machine receiving ability storing device for storing the machine receiving ability information of a receiving device;
wherein in case the machine receiving ability information of the receiving device is previously stored in the machine receiving ability storing device, the processor for selecting selects the transmission by a single electronic mail as the transmission method of the image data regardless of the priority condition, and the image data formed in accordance with the machine receiving ability information is transmitted by the transmission of the single electronic mail.

12. The Internet facsimile machine according to claim 9 further comprising a processor designating whether or not to request a delivery confirmation mail at the time of transmission.

13. An Internet facsimile machine comprising:
a processor having an ability exchanging function for forming an electronic mail including standard format image data and format information of original image data, transmitting the electronic mail, receiving an electronic mail having machine receiving ability information and transmitting the image data formed in accordance with the machine receiving ability information from the original image data; and
a means for determining whether or not to use the ability exchanging function for the transmission of the image data in accordance with a state of the Internet facsimile machine when transmitting the image data.

14. The Internet facsimile machine according to claim 13, wherein the state of the machine is an amount of memory available for storing image data.

15. The Internet facsimile machine according to claim 13, wherein the state of the machine is a frequency in use per time of memory.

16. The Internet facsimile machine according to claim 13 comprising:
a machine receiving ability storage means for storing the machine receiving ability information of a receiving device;
wherein in case the machine receiving ability information of the receiving device is previously stored in the machine receiving ability storage means, the image data formed in accordance with the previously stored machine receiving ability information, is transmitted without using the ability exchanging function.

17. A method of processing electronic mails comprising:
forming an electronic mail using an ability exchanging function wherein the electronic mail includes standard format image data and format information of original image data;
transmitting the electronic mail;
receiving an electronic mail having machine receiving ability information;
transmitting the image data formed in accordance with the machine receiving ability information from the original image data; and
determining whether or not to use the ability exchanging function for the transmission of the image data in accordance with a state of the Internet facsimile machine when transmitting the image data.

18. The method according to claim 17 further comprising determining the state of the machine as an amount of memory available for storing image data.

19. The method according to claim 17 further comprising determining the state of the machine as a frequency in use per time of memory.

20. The method according to claim 17 further comprising storing the machine receiving ability information of a receiving device, wherein in case the machine receiving ability information of the receiving device is previously stored, the image data formed in accordance with the previously stored machine receiving ability information is transmitted without using the ability exchanging function.
